(19) United States
(12) Patent Application Publication
(10) Pub. No.: US 2005/0168443 A1
(43) Pub. Date: Aug. 4, 2005

(54) Method and apparatus for producing one-dimensional signals with a two-dimensional pointing device

(76) Inventor: Paul J. Ausbeck JR., Campbell, CA (US)

Correspondence Address: INGRASSIA FISHER & LORENZ, P.C., 7150 E. CAMELBACK, STE. 325, SCOTTSDALE, AZ, 85251, US

(21) Appl. No.: 10/999,400

(22) Filed: Nov. 29, 2004

Related U.S. Application Data
(60) Provisional application No. 60/540,534, filed on Jan. 29, 2004.

(51) Int. Cl. G09G 5/08

(52) U.S. Cl. 345/163

(57) ABSTRACT

Various methods for generating one-dimensional GUI signals from two-dimensional mouse movements are described. The methods can be modal, allowing the mouse to be used for both two-dimensional and one-dimensional tasks. Within a single one-dimensional modal invocation, unbounded signals of either polarity can be produced while remaining within a bounded two-dimensional area and without leaving the pointing surface. The magnitude of generated one-dimensional signals is proportional to the two-dimensional distance traveled by the mouse.

### CROSS-REFERENCE TO RELATED APPLICATIONS

This application claims the benefit of U.S. Provisional Application No. 60/540,534, filed Jan. 29, 2004, which is incorporated herein by reference.

### TECHNICAL FIELD

The present invention generally relates to using a two-dimensional pointing device such as a computer mouse for producing one-dimensional GUI inputs such as scrolling signals.

### BACKGROUND

The graphical user interface, or GUI, has become the standard paradigm for human interaction with personal computers. A typical GUI includes a screen for displaying graphical elements and a pointing device for interacting with these elements. A primary function of the pointing device is to select among multiple simultaneously-displayed GUI elements by moving an indicator of attention, such as a cursor, over the desired element. A secondary function of the pointing device is to carry buttons or other controls for interacting with the GUI element attaining the point of attention. For example, a GUI “button” is conventionally “pressed”by moving the cursor over a visible facsimile of a button on the display screen and pressing a physical button associated with the pointing device.

One of the most important GUI tasks is spatial navigation of electronic documents, which is traditionally performed by interacting with scrollbars along a document's periphery. FIG. 1 shows a typical text document window with associated scrollbars. The vertical scrollbar is shown on the right of the window and the horizontal scrollbar is shown at the bottom of the window. In the example of FIG. 1, the window is wide enough to view the entire document width without scrolling, so the horizontal scrollbar is inactive. The vertical scrollbar shown has line up and down arrows at its ends, page up and page down areas toward the interior, and a scroll thumb between the paging areas. The location of the scroll thumb conventionally provides an indication of the position of the visible portion of the document within the entirety. The size of the scroll thumb conventionally provides an indication of the currently-visible percentage of the document.

Clicking the left pointing device button on the relevant scroll bar arrow scrolls the viewed document up or down one line. Clicking on the relevant paging area scrolls a document up or down one page. Grabbing the scroll thumb by pressing and holding the left button while over the thumb allows the thumb to be moved directly by subsequent pointing device movement. One pixel of thumb movement scrolls the document by an amount that varies with document length. The variation is such that the relevant document extremum is smoothly reached just as the scroll thumb reaches its extent of motion. So, for short documents one pixel of thumb movement may equate to one pixel of document scrolling, while for long documents one pixel of thumb movement may equate to multiple document pages. The characteristics described in this paragraph are typical, but can vary from application to application.

One widely recognized problem with scrollbars is that the point of attention must move from the document to its periphery and back again to switch between navigation and other GUI tasks. Because of this, several mechanisms for effecting scrolling directly from pointing device collocated hardware have recently become available. As part of this trend, standardized methods of making pointing-device-originated scrolling information available to applications have arisen. Further, many more-recent PC applications take advantage of these signals for one-dimensional tasks other than scrolling.

The most widely deployed of these native one-dimensional navigation widgets is the mouse wheel. Typically sited between the left and right mouse buttons, the wheel is optimized for performing vertical scrolling, and many modern systems will by default perform the vertical scrolling operation as it is rotated. The wheel can be used for alternate one-dimensional navigation functions by supplying extended modal information. For example, a popular spreadsheet program zooms in or out, thereby making less of the sheet visible with more detail or more of the sheet visible with less detail when the keyboard Ctrl key is pressed at the same time that the wheel is rotated up or down, respectively.

The market success of the scroll wheel has demonstrated that the ability to directly perform one-dimensional GUI tasks is a desirable mouse feature. However, the scroll wheel suffers from several problems that make it less than optimal for generalized one-dimensional GUI input. First, the range of speeds addressable by the wheel is quite small. The wheel is positioned for operation with the forefinger and can be turned in a given direction by only a relatively small amount before the finger must be lifted from the wheel and replaced to allow further movement. Further, wheel rotation is typically detented with only several detents passable on each repositioning of the finger. Because detents are typically only capable of being passed at a relatively slow rate, either the maximum input speed is relatively slow or the minimum task increment is relatively large.

A more important limitation of the wheel is that it is generally difficult to both turn the wheel and provide extended modal information with the same hand. This makes it problematic to modally switch the wheel among different one-dimensional tasks. For example, the previously mentioned spreadsheet zoom feature demands use of the free hand to provide extended modal information via the keyboard. Perhaps the most significant drawback of the mouse wheel is that it is mechanically more complex than the rest of the modern optical mouse. This complexity adds to the cost of manufacture and is a significant contributor to post-deployment failure.

In summary, the mouse wheel is an essentially ad hoc solution to the fundamental problem of direct one-dimensional GUI input and has a number of significant drawbacks. The wheel is relatively expensive and unreliable. It ties up the most dexterous digit of the hand and makes it problematic to modally redirect input. Additionally, the low dynamic range generally must be compensated for by additional operational modes that limit its usefulness for one-dimensional tasks other than scrolling.

Accordingly, a general method for converting two-dimensional mouse movements to one-dimensional GUI variables is needed. In order to most effectively harness the mouse's inherently large dynamic range, such a dimensionality reduction technique should be substantially zero-order (as described below) to maximize nuance and control and to minimize mental fatigue. It should allow for the generation of both positive and negative values within the same modal invocation. It should provide an extremely wide dynamic range so that without lifting the mouse both the smallest and largest expected excursions can be easily and efficiently accommodated. It should self-center in that there should be a high degree of freedom to move arbitrary distances in the one-dimensional task space while remaining near a central location in the two-dimensional input space. Furthermore, other desirable features and characteristics will become apparent from the subsequent detailed description and the appended claims, taken in conjunction with the accompanying drawings and this background.

### BRIEF SUMMARY

Various exemplary embodiments of the invention include methods for generating one-dimensional GUI signals from two-dimensional mouse movements. The methods can be modal, allowing the mouse to be used for both two-dimensional and one-dimensional tasks. Within a single one-dimensional modal invocation, unbounded signals of either polarity can be produced while remaining within a bounded two-dimensional area and without leaving the pointing surface. The magnitude of generated one-dimensional signals is largely proportional to the two-dimensional distance traveled by the mouse.

Once a one-dimensional mode has been entered, an initial polarity is established from an initial direction of travel. When sufficient turning in a particular direction has occurred, the initial polarity is associated with that turning direction. Polarity may be reversed by abruptly reversing direction or, after polarity has been associated with a turning direction, by turning sufficiently in the opposing direction from the polarity-associated direction. Upon each reversal in polarity, the reversed polarity is disassociated with a turning direction. A new association occurs upon sufficient post-reversal turning.

While designed for use with a mouse, the methods and systems described herein can be used with any pointing device capable of producing relative motion inputs, as described more fully below. Various exemplary embodiments of the methods suitable for embedded use in typical pointing device controllers are disclosed.

### BRIEF DESCRIPTION OF THE DRAWINGS

The present invention will hereinafter be described in conjunction with the following drawing figures, wherein like numerals denote like elements, and

FIG. 1 shows a conventional GUI window with active vertical and inactive horizontal scrollbars.

FIG. 2 shows an exemplary input path and its dimensionality-reduced output variable.

FIG. 3 shows an exemplary initial sign assignment from an initial travel direction.

FIG. 4 shows an exemplary fixed chirality association.

FIG. 5 shows an exemplary lazy chirality association.

FIG. 6 shows an example of how chirality association requires contiguous turning.

FIG. 7 shows an exemplary relamotive chiral mapping.

FIG. 8 shows eight exemplary approximate headings, or octants, that lend themselves to efficient calculation of relevant direction parameters.

FIG. 9 shows an exemplary flow chart for establishing an octant heading that most closely approximates a motion report.

FIG. 10 shows an exemplary flow chart for establishing an incremental change in a one-dimensional output variable from a motion vector and an octant heading.

FIG. 11 shows an exemplary flow chart for producing a canonicalized motion vector from an octant heading.

FIG. 12 shows an exemplary flow chart for finding a related octant heading from a given octant heading and a turning amount.

FIG. 13 shows an exemplary flow chart for finding the turning amount necessary to move from one octant heading to another.

FIG. 14 shows an exemplary flow chart for locally integrating motion reports to obtain a valid filtered direction of travel.

FIG. 15 shows an exemplary flow chart for relaxing direction changes that are less than the amount required for reversal but greater than one octant to exactly one octant.

FIG. 16 shows an exemplary flow chart for determining if three approximate headings are compatible.

FIG. 17 shows an exemplary flow chart for accumulating activity statistics that determine whether or not to change an octant heading.

FIG. 18 shows an exemplary flow chart for associating a one-dimensional polarity with a chirality.

FIG. 19 shows an exemplary flow chart for determining an octant heading change amount.

FIG. 20 shows an exemplary flow chart for initializing reductive state variables.

FIG. 21 shows an exemplary flow chart for augmenting a one-dimensional output variable from a motion report and a current sign.

FIG. 22 shows an exemplary flow chart for extracting an integral portion of a one-dimensional output variable for delivery to a GUI subsystem.

FIG. 23 shows an exemplary flow chart for sensing an initial sign from a sequence of motion reports.

FIG. 24 shows an exemplary overall flow chart for reducing a sequence of two-dimensional motion reports to a sequence of one-dimensional GUI variable reports.

FIG. 25 shows an exemplary overall flow chart for monitoring a stream of mouse reports and modally switching between two-dimensional and one-dimensional GUI tasks.

FIG. 26 shows an exemplary progression of state variables used in sensing an initial sign.

FIG. 27 shows a state variable progression resulting from an exemplary linearly induced sign inversion.

FIG. 28 shows a state variable progression resulting from an exemplary rotationally induced sign reversal.

FIG. 29 shows an exemplary state variable progression resulting from an adapted linearly induced sign reversal.

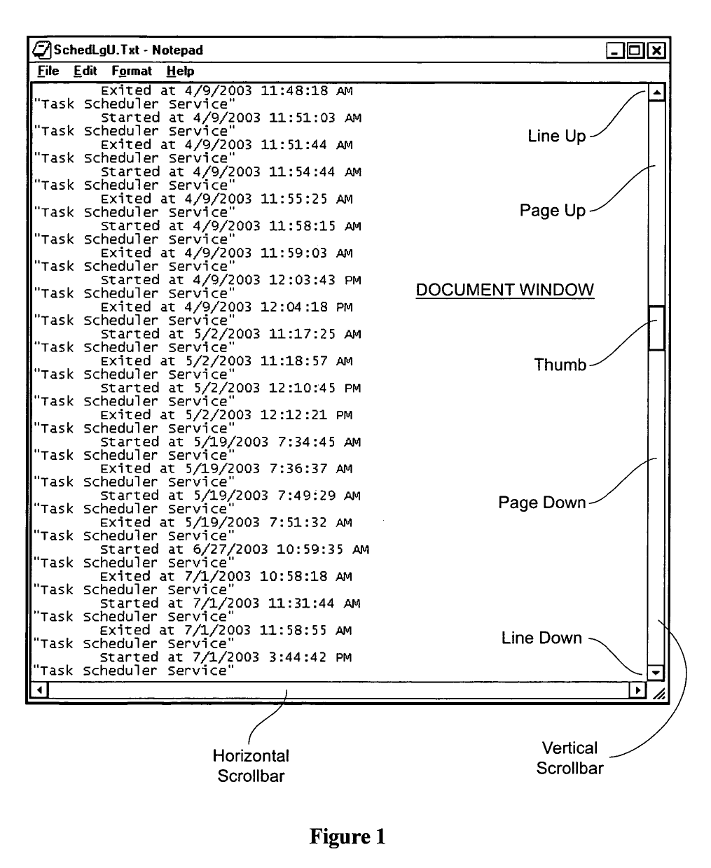

### DETAILED DESCRIPTION

According to various exemplary embodiments, a new technique for converting two-dimensional inputs from a mouse or other input device to one-dimensional signals allows for scrolling or other user interface navigation tasks without the various shortcomings of the prior art. In one such technique, the input device is placed into an operating mode that produces one-dimensional signals having a polarity and a magnitude in response to two-dimensional movement of the input device. As the user moves the input device, two-dimensional signals corresponding to the motion are processed to determine distance measurements relating to the motion. The distance measurements are used to determine the magnitude of the resulting one-dimensional signal. In a further embodiment, the polarity of the one-dimensional signal is determined from the direction of the two-dimensional movement. As a result, a low-order technique exhibiting a wide dynamic range is provided that overcomes many of the shortcomings described above. The various techniques and systems described herein are applicable in a wide array of environments, and may be implemented in any manner, using any combination of hardware and/or software. Further, the signal and data processing techniques described herein may be implemented in any software language or environment. Such software may reside within a mouse or other input device, for example, or may reside in memory or other data storage within a computing host that communicates with a pointing device, or in any other device or location.

The concepts described herein may be implemented with a wide range of input devices, including mice, trackballs, joysticks, inertial sensing devices, video game controllers and the like. In particular, the techniques described below are well-suited for so-called “relamotive” devices such as mice and joysticks. Relamotive use implies that mapping decisions are based upon distance and direction information rather than information about absolute position, force, etc. A relamotive pointing device such as a mouse, joystick or the like therefore reports movement of the device or a component of the device rather than (or in addition to) absolute position of the device or component. If such devices are moved to a limit of motion in a particular direction (e.g. an edge of a mousepad or other working surface for a mouse), the relamotive device is typically disengaged from the working surface and replaced at a location away from the limit before further motion in that direction can occur. Avoiding these re-centering operations would conventionally dictate that a single movement should not often approach the limits of motion. To overcome this aspect of relamotive devices, the various techniques described herein allow for extended scrolling (or other one-dimensional movement) in response to two-dimensional movement of the device.

Terminology

Before looking at various ways of improving one-dimensional input it will be instructive to develop some terminology applicable to GUI input in general. Because it is a more mature field, two-dimensional input, or pointing, will be used to motivate this development.

Dynamic Range

The dynamic range of a GUI task is its maximum expected task rate divided by its minimum. For the canonical GUI task of pointing, the maximum rate generally occurs when throwing the cursor across a high-resolution screen. Modem screens may be more than two thousand pixels wide and since users typically desire to traverse the entire screen in a fraction of a second, a task rate in excess of two thousand pixels/second is commonly used. Conversely, no matter how large the display screen, small features such as window sizing borders must still typically be acquired. The minimum feature size that must be addressed by a GUI task is its resolution, and for the pointing task the required resolution is generally a single pixel. The time taken to address a single pixel can of course be arbitrarily long, leading to arbitrarily low minimum pointing rates. However, it is uncommon for users to spend much more than one second on the fine-tuning portion of a GUI task. Therefore a task's dynamic range can be normalized by assuming that its resolution is accessible in a time span on the order of one second.

Defining a task's resolution as ^{R}, its smallest task rate as ^{R}L, and its largest task rate as R_{H}, the task's dynamic range formulation can be simplified as follows:

$$D = \frac{{R}_{H}}{{R}_{L}} ≅ \frac{{R}_{H}}{\frac{R}{1 second}} . \qquad ( 1 )$$

For pointing this results in a required pointing dynamic range of:

$${D}_{P} > \frac{2000 pixels \text{/} second}{1 pixel \text{/} second} = 2000. \qquad ( 2 )$$

In order for an input device to efficiently perform a particular GUI task, the device's dynamic range should reasonably match the task's dynamic range. Using terminology similar to that for tasks, the dynamic range of an input device can be defined as its maximum device rate divided by its minimum. Again normalizing by making a one second minimum device time assumption, a device's dynamic range is equivalent to the total number of minimally resolved input units that it can report in one second.

For a mouse, the maximum device rate is calculated by multiplying the largest amount of motion that can be delivered in a single report by the number of reports that can be made in one second. The traditional name for the minimally resolved mouse movement is the “mickey”, and a modem USB mouse can report up to 128 mickeys of motion at a report rate of up to approximately 120 times per second. Therefore the mouse's raw dynamic range is:

$${D}_{M} ≅ \frac{128 mickeys}{report} \times \frac{120 reports}{second} > 10 \text{,} 000. \qquad ( 3 )$$

This is more than enough to accommodate the pointing task, but unfortunately another factor conspires to limit mouse dynamic range.

A relamotive pointing device, such as a mouse, reports movement rather than or in addition to absolute position. If moved to the limit of motion in a particular direction, to report further motion in that direction it must typically be disengaged from its working surface and replaced at a location away from the limit. Avoiding these re-centering operations generally requires that a single movement should not often approach the limits of motion. A rule of thumb that minimizes the need for re-centering is to limit any single pointing device movement to substantially less than 50% of its working space.

For example, a comfortable mouse working space is generally about four to five inches in diameter. Yielding to the single move rule of thumb means that approximately two inches are available for the largest expected move. Given a typical mickey resolution of 1/400 of an inch, and a unity gain system, where one mickey of mouse motion produces one pixel of display movement, a typical mouse can move the cursor 400×2 =800 pixels in two inches. Therefore, the space limited mouse dynamic range in this example is less than half that required for use with a 2000 pixel wide display and less than one tenth the raw dynamic range.

It is useful to note that an input device is space constrained only when making linear movements in the device space. Movements that follow a closed path are not necessarily space constrained. For example it is quite feasible to maintain a mouse speed roughly akin to its raw dynamic range, 10,000 mickeys/second, by continually moving the mouse in a five-inch diameter circle.

Ballistics

One common approach to making up the deficit between available device and required task dynamic range is to interpose a non-linear processing function when forming task variables from device variables. In pointing device parlance these processing functions are called “ballistics functions”. The name is suggestive of an input device being influenced by external forces in the same way that a projectile's path is influenced by environmental factors such as gravity and wind. In the computer-input domain, however, the “external” forces at play are the artificially interposed ballistics functions.

In the simplest GUI input system, task variables are obtained from device variables by applying a unity gain:
g(t)=1·d(t)(4) (4)

That is, device variables essentially equate to GUI task variables. For instance, a unity gain pointing system always moves the cursor one pixel for each mickey of reported device motion. The objective of a ballistics function is to expand the task dynamic range by applying a smaller gain to relatively small device inputs and a larger gain to relatively large device inputs. This is formulated mathematically as follows:
g(t)=B(d)·d(t) (5)

At each time step, GUI variables are typically formed from device variables by applying a device variable dependent gain. For example, one of the earliest ballistics functions for use with mice involved doubling the size of device reports larger than four and again doubling reports larger than ten. Using C ternary operator syntax, a more formal description is as follows:
B(d)=d≦4?1:(d≦10?2:4) (6)

This scheme works because a mouse reports its motion at a regular rate unless there is less than one mickey of motion to report, in which case nothing is reported and any potential fractional mickey is retained for combination with subsequent motion at the next reporting point. So, while the mouse is moved slowly it either reports nothing or one mickey. As the speed of motion increases, the frequency of one mickey reports increases until the full report rate is attained. Beyond the full report rate, the number of mickeys per report increases. Since a typical mouse may have a report rate of 120 reports/second, if reports contain more than one mickey the mouse is moving relatively quickly, 600 mickeys/second in the case of five mickeys per report.

Since a five mickey report indicates relatively rapid mouse movement anyway, the distance can be doubled in the pixel space with the user only noticing that the cursor is moving faster. The net result is that the cursor can be more quickly thrown across the screen by a short movement that rapidly increases and then decreases in speed. Once the cursor is near the target, movement slows enough so that the extra gain is no longer applied, resulting again in full single-pixel control.

While ballistics functions are useful for expanding the dynamic range of a device, the increased range comes at the expense of decreased controllability. Fortunately, this decreased controllability is typically encountered at high speeds and is substantially masked by that speed. However, there is a limit to how far a dynamic range can be expanded via a ballistic function without substantially impacting both user perceived and actual levels of control. The rule of thumb limit for common GUI tasks is about 10× expansion of native device dynamic range.

Higher Order Operation

As was shown previously, the chief factor limiting mouse dynamic range is the size of the work area. Ballistics functions were shown able to expand the dynamic range of a device but somewhat at the expense of controllability. A principle that applies generally to many input devices is that the controllable dynamic range of an input device is largely proportional to the size of its working area.

In situations where device size is particularly constrained, task controllability can be further traded off against size by yet another processing technique referred to as higher order operation. The operational order of a device dictates how changes in the input, or device variable, propagate to changes in the output, or GUI task variable. Mathematically, the order relates to the number of derivatives that connect the input/output relationship. An operational mode where the output variable is proportional to the input variable is a zero-order mode, for example equation (4). A mode where the first derivative of the output variable is proportional to the input variable is a first-order mode. The first-order relationship is expressed in differential form as:

$$\frac{ⅆ g ( t )}{ⅆ t} = d ( t ) , \qquad ( 7 )$$

and in integral form as:

$$g ( t ) = {\int }_{t} ⅆ ( t ) ≡ D ( t ) . \qquad ( 8 )$$

Although operational modes higher than first-order are somewhat impractical, a second order mode would connect via the second derivative and so on.

The idea behind first-order operation is that relatively small changes in the input variable can accumulate over time into relatively large changes in the output variable. To further concretize this idea for relamotive devices, both the input variable ^{d(t)} and the task variable ^{g(t)} refer to how far to move in the time interval t, not where to move. A second notion implied by relamotive operation and the time integral of the input is that of absolutism in the input space. In order for motion in the output space to cease in most devices, ^{g(t)} must go to zero implying that ^{D(t)} must also go to zero. In order for ^{D(t)} to go to zero the integral of ^{d(t)} over a particular time interval must be zero. This implies the notion of a zero point or home location in the input space. Any deviations of one polarity in the input space will continue to generate periodic output space signals until cancelled by input space movements of the opposite polarity. Because output signals can continue to be generated even when input motion ceases, first order modes are sometimes referred to as “automatic” modes. Note that the time base used to generate automatic output signals is typically different from that used to report input motion and that output signals are typically not contemporaneous with input motion.

A non-linear ballistics function can also be applied to a first-order operating mode. As it admits simpler analysis and implementation, it is traditional to apply ballistics to the time integral of the input:
g(t)=B(D)·D(t) (9)

Note that ballistics can shape the proportionality of the input and output but do not change the basic operating order.

The most widely deployed pointing device commonly operated first-order is the isometric joystick, a rubberized nub used for pointing on many laptop computers. Because it does not perceptively move, the isometric joystick can be even smaller than other devices operated first-order, small enough to fit between slightly modified G and H keys of a standard keyboard, for example.

The input variable produced by an isometric joystick is a measure of force applied, typically with the forefinger. First-order operation makes the display cursor speed proportional to this force. Because the range of forces that can be either comfortably applied or comfortably resolved by a human finger is insufficient to accommodate fast cursor motion and single pixel resolution, a ballistics function is often incorporated in joystick systems. In practical systems, these functions have dynamic range expansion ratios in excess of 20:1.

An attribute of isometric devices that makes them particularly suited to first order operation is that the first-order integrator can be discharged faster than is possible with moveable devices. This is because reversal of an isometric device requires only a reversal of the force applied. For a moveable member, an additional time following reversal of applied force is required to take up the slack of one polarity before the opposite can be generated. The faster integrator discharge time of an isometric device leads to superior controllability over a moveable device when both are operated first order.

Perhaps the main drawback to pointing use of isometric joysticks is that first-order operation and expansive ballistics functions both conspire to limit controllability. While many users are deft enough to use them efficiently, others are not. This factor makes the isometric joystick potentially unsuitable as a universally accepted pointing device.

Modality

Another concept that will is needed to produce both one and two-dimensional signals using a single device is that of modality. This concept can also be fruitfully examined in the context of pointing. In modal use a single device data stream is directed to more than one GUI task via supplemental informnation. This extended modal information is often contained in the device data stream but can also be provided by entirely separate sources. The particular information that causes dispatch of data to a particular mode is called the modal indicator for that mode. In the absence of extended modal information or in the default modal state, device data is dispatched to its normal or home mode.

For example, two-dimensional input data is modally switched between the GUI pointing and dragging tasks via extended modal information in the form of button state. Typically the button state is associated with the same device that generated the pointing data and is delivered contemporaneously with that data. For a mouse, the dragging modal indicator is the down state of the primary, generally left, mouse button. The home mode of the mouse is pointing, indicated by the up state of its left button.

Extended modal information can come from multiple sources at the same time. For example, some GUI's allow the dragging operation to be further bifurcated to either move or copy data. The modal indicator for copying is typically the down state of the mouse left button and the down state of either keyboard Shift button. Moving is the default or home dragging mode and is indicated by the down state of left mouse button and the up state of both keyboard Shift keys.

Dimensionality Reduction

There are many possible techniques for mapping from a two-dimensional to one-dimensional space. One simple mapping would be to discard one of each pair of two-dimensional coordinates. For example, simply discarding the conventional vertical coordinate (i.e. the “Y” coordinate in a conventional (X, Y) pair) would result in a one-dimensional variable that increased to the right and decreased to the left. In relamotive use this variable would be positive when moving to the right and negative when moving to the left. However, this sort of mapping would not solve the problem of generating an unbounded one-dimensional variable from bounded two-dimensional movements. After attaining the leftmost two-dimensional boundary, any further one-dimensional outputs would be to the right and therefore positive. Generation of an arbitrarily large negative output—or positive output for that matter—is extremely difficult if not impossible using this simple mapping due to the inherently bounded nature of the two-dimensional space available for using the device.

As a result, one desired attribute of a generally useful reductive mapping is that unbounded outputs be synthesizable from bounded inputs. One way of visualizing this is that the potentially infinite one-dimensional space can be “folded up” so that it fits within the fixed size two-dimensional space. Conversely, a folded up two-dimensional path may be thought of as being unwound and laid along a single dimension. By way of analogy, a runner completing twelve laps on a quarter mile track has run three miles in the output space, but the runner's starting and stopping location in the input space are the same. Similarly, two-dimensional movement of a mouse on a pad or other work surface can be translated to an unbounded movement in one dimension. Stated in mathematical terms, the sum of the magnitudes of the relamotive reports (representing the total amount of movement) is substantially greater than the magnitude of the sums of the relamotive reports (which represents the net movement from the starting position). Even though the relamotive device has not moved substantially from its starting position, a substantial amount of movement may have taken place. The term “substantially” in this sense is simply intended to imply an amount greater than could be accounted for by accidental deviation from a straight path or due to measurement error.

A second desired attribute is to exploit the bounded input space in the dynamic range sense. Larger input spaces should admit larger magnitudes and therefore faster accumulations in the output space. For instance, a reductive mapping of rotational movements could be formulated that bases output magnitudes on subtended angle traversed. However, this sort of mapping would produce identical output magnitudes no matter how large the circle being traversed. Since smaller circles can be physically traversed faster than larger ones, such a mapping would undesirably have an inverse relationship between input space size and dynamic range.

A third desired mapping attribute is that it should be easily learnable by humans. Contemporaneous regular feedback is a primary attribute that determines the learnability of a mapping. In order to provide good feedback, a mapping should be configured to produce movement in the output space whenever there is movement in the input space. Dead spots or dead directions in the input space should be avoided to the extent that it is convenient and possible to do so.

A fourth desired mapping attribute is that it should be intuitive. Familiar motions should generate expected results. The two most common control gestures are linear and rotational motions, and as linear motions are natural for small excursions and circular motions natural for larger movements, a unified mechanism for handling both is desirable. Unification of these two types of motion for dimensionality reduction is primarily a function of proper sign management. A continued linear movement in a single direction should not cause a sign reversal, whereas, a distinct reversal in direction during a linear movement should cause a sign reversal. A continued turning movement of a certain handedness should not cause a sign reversal, whereas a distinct reversal in handedness of a rotational motion should cause a sign reversal.

For convenience of implementation, the mapping may be separable in the sense that one input attribute generates the output sign and a second input attribute generates the output magnitude. Transferring the size-proportional dynamic range requirement on the input space to the output suggests generating output magnitudes from input distances. That in turn suggests an input direction and distance description similar to the widely known polar coordinate description. Applying the principle of separability and using input distance to determine output magnitudes leaves input direction to determine output sign. A reductive mapping based upon these principles is described next.

Signed Reductive Mapping

The various principles of Table 1 collectively generate an exemplary reductive mapping with the previously-discussed properties. The mapping is potentially unbounded in that the output sign can remain unchanged as long as linear and rotational reversals are avoided. Since output magnitudes are largely proportional to input distance traveled, output dynamic range is proportional to input device size and output dead spots or dead directions are substantially avoided. Output sign changes from linear motions are accommodated via the abrupt direction reversal criteria and changes from rotational motions are accommodated via the turning direction reversal criteria. The mapping is inherently separable in that output sign is dependent upon input direction and output magnitude is dependent upon input distance.

TABLE 1
Exemplary Reductive Principles

| | |
|---|---|
| P1 | The one-dimensional sign should invert when the direction of two- |
| | dimensional travel abruptly reverses. |
| P2 | The one-dimensional sign should invert when sufficient two- |
| | dimensional turning occurs in opposition to the direction of turning |
| | associated with the current one-dimensional sign. |
| P3 | The one-dimensional magnitude should be largely proportional to the |
| | two-dimensional distance traveled. |

To further concretize how these principles can be practically applied, it will be useful to define discrete two-dimensional relamotive variables (“reports”), which may be appropriately represented by a sequence of ^{(Δx, Δy)} pairs. In the exemplary embodiment described below, each report appropriately represents the amount of motion accumulated by two orthogonal underlying continuous device variables in a sample period. For example, in a conventional coordinate system a computer mouse report of (1,1) indicates that the mouse has moved one reference unit (e.g. “mickey”) away from the user and one reference unit to the user's right in the interval since the last report.

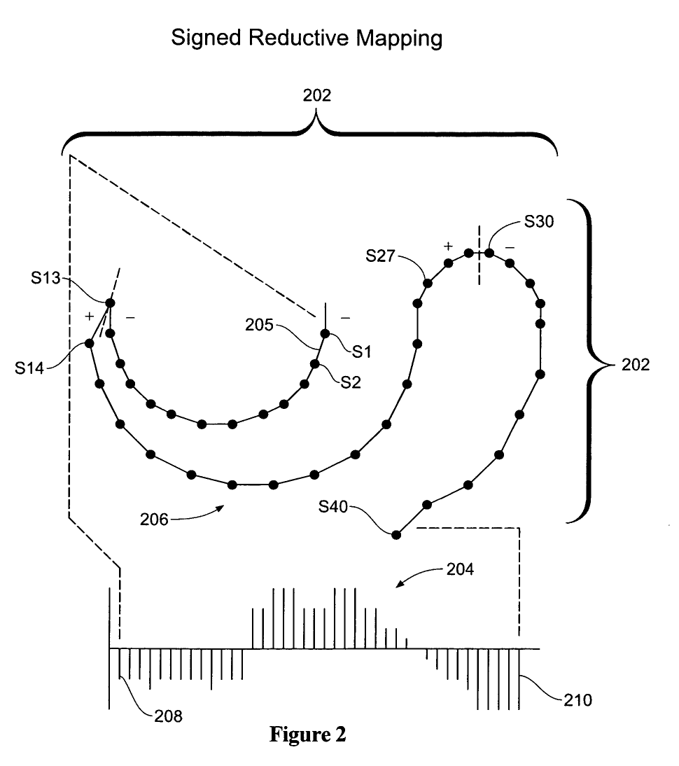

Turning now to the drawing figures and with initial reference to FIG. 2, an exemplary sequence of reports S1-S40 conceptually laid end-to-end represent a path 206 of an input device through two-dimensional input space 202. Each report composing path 206 is shown in one-to-one correspondence with a particular segment of that path. The exemplary path 206 shown in FIG. 2 therefore contains forty segments, with each segment preceding one of the various reports S1-S40. Segment 205, for example, corresponds to report S2 and represents a straight-line approximating the movement traversed by the input device between reports S1 to S2.

Given the framework of an input path, the main work of a reductive mapping technique can be accomplished by labeling each segment of the path with a sign and magnitude. Assembling these sign/magnitude pairs into a single signed variable then straightforwardly produces an associated one-dimensional output variable stream 204. In the one-dimensional output signal stream 204 shown in the lower portion of FIG. 2, report S1 of two-dimensional input path 206 generates the first signal 208 of output stream 204, and report S40 generates the last signal 210. Alternate signal generation and mapping schemes, however, may be used in various equivalent embodiments.

In the context of the previously-listed reductive principles, sign labeling in the one-dimensional signal stream 204 can be seen as a steady state process of labeling each segment of path 206 with the sign of the previous segment, augmented by an inversion process that detects linear and rotational direction reversals in the two-dimensional movement represented by path 206. Linear reversals generally have priority in that they can typically be detected more quickly than rotational reversals. In the example shown in FIG. 2, a linear reversal occurs between reports S13 and S14 and is intuitively detectable from only the information in those two reports. In comparison, the rotational reversal that begins near report S27 is ambiguous until significantly later, perhaps near report S30.

Labeling a path segment with a magnitude is relatively straightforward when compared with sign labeling. According to the third reductive principle (P3), a path segment's magnitude can be determined to be largely proportional to the length of the segment. The most commonly used length measure is the Euclidian distance, \sqrt{Δx²+Δy²}, but computationally simpler methods or the like may be implemented and/or augmented in various other embodiments. The exemplary magnitudes shown in signal stream 204 of FIG. 2 were generated via a slightly modified absolute distance measure that attenuates motion near potential rotational reversals, although such enhancement may not be present in all embodiments.

Direction, Chirality And Sign

The principles in the previous section outline an exemplary sign evolution from prior state given particular input motions, but thus far there has been no discussion of establishing an initial state from which to evolve. One state variable to be initialized is the output sign label. As was mentioned previously in regard to reversals, linear motions can generally be more quickly resolved than rotational ones. This is because rotational motions can, to a user perceived level of accuracy, be decomposed into multiple linear motions. The various segments that make up path 206 in FIG. 2, for example, may each be thought of as linear approximations of two-dimensional rotational movements between reports. The delay in determining an initial sign can therefore be reduced by determining the sign from linear motions rather than rotational ones. This sign initialization principle is summarized in Table 2.

TABLE 2
Exemplary Initial Sign Principle

| | |
|---|---|
| P4 | The initial one-dimensional sign should be determined from an initial |
| | direction of travel. |

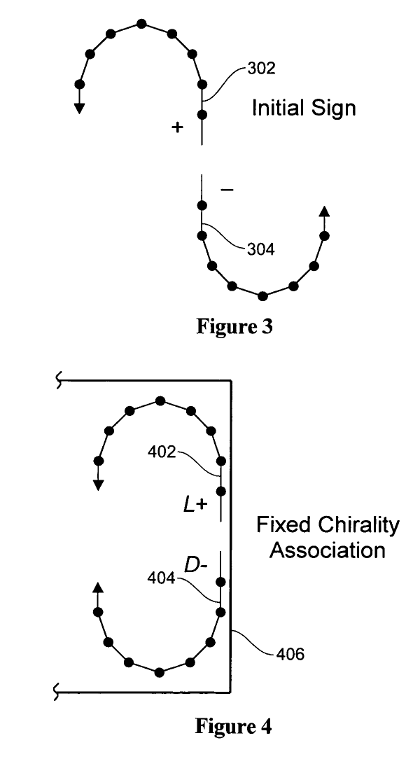

An example of a sign initialization technique appropriate for a vertically-aligned output variable is shown in FIG. 3. According to this technique, initial upward movement 302 is defined to produce an initial positive sign, whereas downward movement 304 is defined to produce an initial negative sign. Note that the rotational direction for both movement 302 and 304 shown in FIG. 3 is identical for both initial signs. That is, although both path 302 and 304 describe counter-clockwise motion, path 302 is positive due its initial upward motion, and path 304 is negative due to its initial downward motion. Nevertheless, this example is indicative of a need for associating different signs with the same turning direction, or analogously, for associating different turning directions with the same sign.

Therefore, another state variable to be initialized represents the direction of turning associated with a sign. Because a single sign can have different associated turning directions and because a sign can be divined more quickly than a rotational direction, the association of turning direction with a sign may be deferred beyond the point of initial sign discovery. The term “lazy” is often used to describe computer algorithms that defer decisions and this terminology will be adopted here for convenience.

To deal more concretely with this concept it is useful to attach a second label to the segments of an input path to indicate its turning preference. Adapting terminology used in chemistry to designate the direction that a molecule rotates plane-polarized light, a “chirality” segment label can be used to describe the “turning preference” or predominant direction of turning of the segment. A preference for left-hand turns (i.e. counterclockwise rotation) may be designated as levorotary (L). Similarly, a preference for right-hand turns (i.e. clockwise rotation) may be designated as dextrorotary (D). A segment with no established chirality may be designated as racemic (R).

For some device and modal entry configurations it is possible to dispense with the racemic state and adopt a fixed association between chirality and sign. For example, FIG. 4 shows initial upward 402 and downward 404 motions at the right-most edge of a bounded pointing surface 406. This situation could arise, for example, when entering a reductive mode via parallel motion along the right-most edge of a touchpad. Because further rightward motion is not possible in this example, initial upward movement 402 necessarily indicates levorotary chirality, and downward movement 404 indicates dextrorotary chirality. As a result, initial movement along the edge of the surface can contemporaneously establish initial values of both output sign and chirality, since subsequent turning in both cases has the expected behavior of preserving the initial sign. The complicating condition of a rotationally induced sign reversal of the initial sign is avoided by the modal geometric constraint.

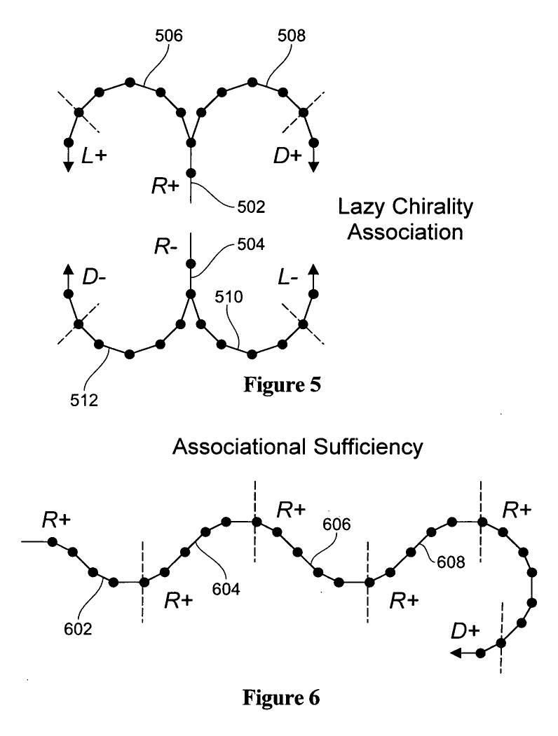

When no prior geometric constraints are available, however, learnability and freedom to keep the device near the center of its work surface are enhanced if either direction of subsequent turning can be associated with an initially established sign. One technique for accomplishing this is to defer establishing an initial chirality until turning sufficient to divine the user's intent has occurred. FIG. 5 shows an example of deferring an initial association between chirality and sign. In this example, “upward” movement 502 can quickly identify a positive sign and negative movement 504 can quickly identify a negative sign, but chirality is initially racemic. A levorotary or dextrorotary chirality may be established after sufficient turning in the initial turning direction. Note that in the above fixed scheme of FIG. 4 only two associations are possible: L+ and D−. In the lazy scheme two racemic states, R+ and R−, lead to four possible associations for chirality and sign: L+, L−, D+, and D−, corresponding to paths 506, 510, 508 and 512, respectively.

The amount of turning required to make an association between chirality and sign should be large enough so that an association is not made until the user's intent is unambiguous but small enough so that the user's intent is not ignored. These two requirements can be contradictory, but one possible resolution would be to make the amount of turning used to establish a chirality association approximately equal to that necessary to cause a sign inversion.

Another complicating issue relates to the manner in which rotation insufficient to establish a chirality association affects the sufficiency of subsequent opposing rotation. Two possibilities for resolving this issue include ignoring previous opposing rotation and aggregating prior opposing rotation to increase the amount of subsequent opposing rotation necessary to establish an association. A factor that favors aggregating rather than ignoring such rotation is that association determinations should be registered with initial directions of travel. This is because users may not precisely follow an initial direction of travel, but may still have an intuitive notion of that direction. With reference to FIG. 6, several opposing turns 602, 604, 606, 608 insufficient to make a chirality association are shown to counter-balance each other; that is, slight turns in opposing directions do not accumulate enough net turning to produce a chirality change. The exemplary points at which the association decision state returns to its initial state are marked with dashed lines in the figure, although other techniques could be used in equivalent embodiments.

As mentioned previously, a motivation for delayed or “lazy” chirality assignment is to avoid unexpected turning-related sign inversions in relamotive use. A basic concept is that rotationally-induced sign inversions generally require a rotational baseline from which to express opposition. Once established, such a rotational baseline can be lost by intervening linear concepts such as abrupt direction reversals. Because of this masking effect, restoring a racemic chirality condition upon linear reversals creates a more intuitive rotational reversal expectation. Also, because it is relatively unlikely that two rotational reversals occur in the absence of any intervening linear reversals, restoring racemic chirality upon rotational reversals as well helps to produce more stable rotational reversal behavior.

An exemplary lazy chirality assignment scheme therefore assigns racemic chirality initially, upon linear reversals, and upon rotational reversals. The amount of turning used to establish a rotational baseline may be designed to approximate or match the amount of turning required to signal a rotational reversal. Baseline associational turning suitably accumulates so that insufficient turning in one direction increases the amount of subsequent oppositional turning necessary to cause an association. These exemplary chirality and sign association principles are summarized in Table 3.

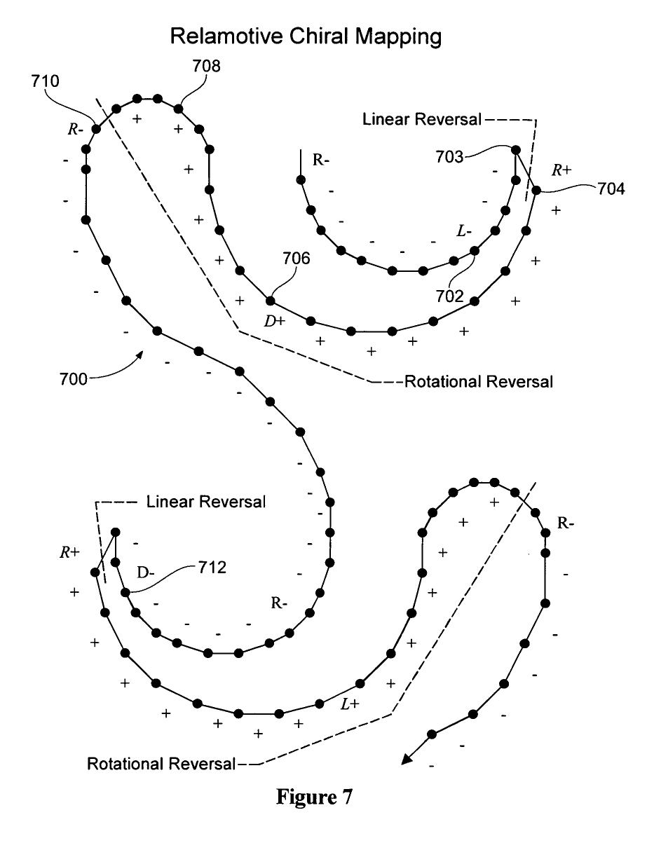

With reference now to FIG. 7, an exemplary input path 700 represented by a sequence of two-dimensional signals/reports illustrates several of the principles in Table 3. As movement path 700 begins, chirality is initially assumed to be racemic (principal P2a). Initial movement appears downward, thereby producing an initial negative sign value. As the reports precess in a generally counter-clockwise manner, levorotary chirality is identified at approximately report 702. A linear reversal occurs between reports 703 and 704, meaning that the sign becomes positive and the chirality is reset to racemic/undetermined in accordance with principal P2d. Clockwise rotation is identified at approximately report 706. Path 700 begins a counter-clockwise rotation at around report 708, which ultimately results in resetting the chirality to racemic (and toggling the sign) at report 710 or so. Due to the subsequent intermixing of clockwise and counter-clockwise motion, the chirality remains racemic (in accord with principal P2c) until clockwise rotation justifies a dextrorotary assignment around report 712. Note that the lower part of the exemplary path 700 shown in FIG. 7 is a mirror image of the upper part. The output sign, however, remains the same for each portion of the path in this example. The overall effect is to maximize the amount of freedom to express an unbounded signed output and to minimize the need for re-centering the input device.

TABLE 3
Exemplary Relamotive Chirality Initialization Principles

| | |
|---|---|
| P2a | The chirality associated with an initialized one-dimensional |
| | sign should be initially racemic. |
| P2b | The amount of turning necessary to establish an association |
| | between chirality and sign should be approximately the same as the |
| | amount of subsequent oppositional turning necessary to establish a |
| | rotational reversal. |
| P2c | Turning motion used to determine chirality and sign associations |
| | should aggregate in that rotation in one direction insufficient to |
| | make an association should increase the amount of opposing |
| | rotation necessary to make the opposing association. |
| P2d | Racemic chirality should be restored upon every output sign |
| | inversion. |

Direction Quantization

Following the previously-described sign maintenance procedure, attention turns to the issue of determining when linear or rotational reversals occur. One issue for embedded use is minimization of the computational resources expended to make reversal decisions. This problem is typically one of state simplification; that is, developing a few key computation points from the relative cacophony of unrestricted two-dimensional input. Since input direction is the criterion that is to be used to make reversal decisions, a fumdamental concept that will be useful toward this end is the idea of direction quantization. If direction is quantized to a relatively few possible values, then heading changes are extremely useful computation points. In this context the fewer the number of possible headings the more efficient heading changes become in making decisions. On the other hand, too few quantized headings may result in loss of user intent, so the number of quantized headings should be as few as needed but no fewer. Quantized headings are also referenced herein as “possible headings” or “buckets”.

In order to avoid quantizer “bucket” artifacts, at least three possible headings should be available in the direction of a reversal so that each forward heading has a directly opposing heading and two opposing headings (one on either side of the opposing heading) that are adjacent to the directly opposing heading as an alignment guard. At least one heading should be provided on each side of the current forward heading to receive rotational progression. If all of the quantized headings are defined to be approximately equal in size, then two progression-receiving headings provide a better balance to the three reversal headings described above. Counting the current quantized heading, then, the minimum number of quantizer buckets used in this exemplary embodiment is 1+2+2+3=8.

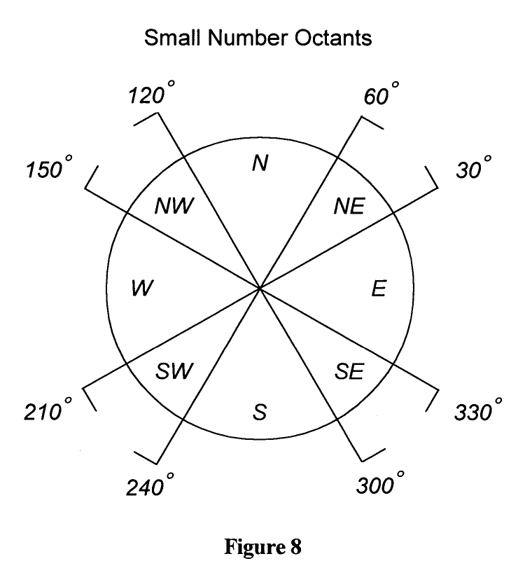

FIG. 8 shows an exemplary non-uniform octant quantizer scheme that is suitable for embedded use in a computer mouse or other input device. As shown in the figure, four axially-aligned “cardinal direction” buckets are arbitrarily defined to be twice as large as the interspersed diagonally-aligned buckets, thereby making quantization decisions possible via integer addition and single bit shifting as described below. In this quantization scheme, “ties” (travel in a direction along the boundary line between buckets) are broken in favor of the smaller diagonal buckets. This scheme results in equal bucket population using the small numbers typically encountered in mouse reports.

By applying relamotive reports from the input device to the quantizer scheme, the approximate heading can be readily identified. Quantizer populations for small positive integer reports in exemplary N and NE buckets are shown in Table 4. Similar allocation schemes can be formulated for each boundary between buckets to assign two-dimensional movement in any direction to a particular bucket.

TABLE 4
Small Number Populations

| N | NE |
|---|---|
| 0, 1 | 1, 1 |
| 0, 2 | 1, 2 |
| 0, 3 | 2, 1 |

Given quantized headings, sign and chirality reversal decisions can be made while processing a device report simply by comparing a persistent heading maintained from past input with a proposed heading formed from past input and the current report. A linear reversal decision may be directly indicated if the persistent and proposed headings differ by three or more octants. A rotational motion may be indicated, for example, if the persistent and proposed headings differ by one octant. Differences of two octants can be relaxed back to a single octant difference, as subsequent motion likely will continue the relaxed progression. As explained more fully below, a rotational motion leaves the current sign unchanged, while a reversal indication causes a sign inversion. Each of these general concepts is exemplary and may be modified, supplemented or replaced in a wide array of alternate embodiments.

In most cases a proposed heading becomes the persistent heading for the next report. However, a slight modification of the octant progression rules results in a unified mechanism for determining both linear and rotational reversals. The modification is to permit one octant heading changes only in the currently preferred chiral direction. If decision statistics are updated regardless of whether or not a heading change is permitted, the result is that rotation against the current chirality will eventually generate a three octant difference between the persistent and proposed headings. When a three octant difference occurs, a reversal is identified using only the linear reversal rule. The exemplary unified sign from direction rules discussed above are summarized in Table 5.

TABLE 5
Exemplary Approximate Heading Principles

| | |
|---|---|
| P1a | An approximate heading can change by either one octant or by |
| | three or more octants. |
| P1b | An approximate heading can change by one octant only in the |
| | direction of a currently established chirality or in either direction if |
| | no chirality has been established. |
| P1c | The one-dimensional sign should invert when two successive |
| | approximate headings differ by at least three octants. |

The previous rules for quantized heading progression unify linear and rotation reversal decisions. A question remains, however as to the basic ambiguity in making linear reversal decisions. Because it is very difficult for a human to precisely reverse the trajectory of a pointing device, it is quite common in practice for a trajectory reversal to contain at least some motion perpendicular to the reversal axis. Further, the more quickly reversal motions are made, the more imprecise they tend to be. A second confounding factor is the small amount of imprecision present in pointing devices themselves. This imprecision is made important by another human tendency, to make rotational movements using the smallest diameter that yields consistent results.

These two human tendencies are conflicting because, on the one hand, small diameter rotations in the context of larger linear movements would typically be ignored. On the other hand, small diameter rotations in the context of other small diameter rotations would typically not be ignored. These vagaries together with the simple computational model of making reversal decisions from two successive approximate headings underscore the importance of approximate headings not changing due to device noise or human imprecision.

A first principle of reducing the effects of imprecision and noise is that a quantized heading should only change following sufficient consistent motion in a new direction. Since consistent motion can accumulate from multiple device reports, sufficiency may need to be established incrementally. For computational simplicity it is desirable that a single scalar value be used to establish sufficiency. Therefore, a mechanism for insuring that only coherent information is used to make sufficiency decisions is needed.

In order for motion to be consistent, the motion should be compatible with a single intent. Motion that is compatible with counterclockwise rotation, for example, lies within the current octant and its two closest levorotary neighbors. Motion compatible with clockwise rotation conversely lies within the current octant and its two closest dextrorotary neighbors. Motion compatible with reversal intent lies completely within the three octants opposing the current octant. Any motion that is incompatible with the current contents of the sufficiency accumulator appropriately results in the accumulator being cleared. Motion that is predominantly in the direction of the current heading should also result in clearing of the sufficiency accumulator. These exemplary heading progression principles are summarized in Table 6.

As mentioned previously, motion sufficient to establish intent in one context may be insufficient in another context. This implies the need for an adaptive progression sufficiency criterion. The two effects that must be considered are device imprecision and human imprecision. The imprecision of a given device is somewhat fixed so the sufficiency criterion should contain a fixed component. Human imprecision is variable and is increased by increased speed of movement. Therefore, a speed-dependent sufficiency component may also be beneficial.

TABLE 6
Exemplary Heading Progression Principles

| | |
|---|---|
| P1d | A quantized heading should only change following sufficient |
| | consistent motion in a new direction. |
| P1e | Sufficiency of consistent motion should be established by |
| | accumulating compatible motion. |
| P1f | Motion in the direction of the three octants opposing the current |
| | octant is compatible. |
| P1g | Motion in the current octant and its two closest levorotary |
| | neighbors is compatible. |
| P1h | Motion in the current octant and its two closest |
| | dextrorotary neighbors is compatible. |
| P1i | Motion spanning more than one of the three compatible directions |
| | is incompatible. |
| P1j | Incompatible motion should clear any previously accumulated |
| | compatible motion. |
| P1k | Accumulated compatible motion that is predominantly in the |
| | direction of the current octant should not be considered in |
| | sufficiency decisions. |

The speed-dependent sufficiency component should track speed changes relatively quickly when speed increases. However, speed can decrease relatively more rapidly than imprecision. This is because deceleration is inherently more difficult to control than acceleration. Therefore, the speed-dependent sufficiency component should only be allowed to decrease relatively slowly. These exemplary progression sufficiency principles are summarized in Table 7.

TABLE 7
Exemplary Progression Sufficiency Principles

| | |
|---|---|
| P11 | The threshold for establishing sufficiency of compatible motion |
| | should include a fixed and adaptive component. |
| P1m | The adaptive sufficiency component should increase rapidly as the |
| | speed of motion increases. |
| P1n | The adaptive sufficiency component should decrease relatively |
| | slowly as the speed of motion decreases. |

A computationally efficient method for decreasing the progression sufficiency criterion is to evanesce the criterion toward the current speed on quantized heading changes. This method is also largely independent of device vagaries such as report rate and should be preferred over time-based evanescent schemes.

Distance and Magnitude

The previously-described reductive principles require that the magnitude of the one-dimensional output variable be largely proportional to two-dimensional distance traveled. In the context of the previously described output sign management principles, a relaxation of this proportionality principle can have utility. The main issue is that the intent of motion may be ambiguous in some contexts. Further, ambiguous motion that is interpreted incorrectly can in some circumstances lead to unexpected outputs.

The context where factors combine most adversely is that of rotationally induced sign inversions. This is because rotational reversals cannot be detected until significant opposing angular turning has occurred. If the diameter of rotation is fairly large, a significant amount of one-dimensional output can be generated between the point where the rotational reversal is initiated and the point where it is detected. This can result in significant overshoot in the direction of the current output sign.

A general principle that helps to ameliorate directional ambiguity is to accumulate for output only the component of input motion that is in the direction of the current octant. This can be done by performing a dot product of an input report and a canonical vector in the direction of the current octant. For computational simplicity the canonical vectors can be limited to various combinations of zero and one. For example, the canonical vector for “north” can be defined as (0,1) and that for “northeast” as (1,1). Again, any directional scheme may be applied, with the various headings assigned to any arbitrary reference. The references to cardinal directions herein are intended simply for example and convenience of reference; in practice any system or arrangement of coordinates and/or directions could be used in a wide array of equivalent embodiments.

In the most common situations it is desirable for output to accumulate rather more slowly than input distance traveled. This is because a single unit of output generally causes a linear GUI presentation to change by more than one pixel. For example, when vertical scrolling is performed with WM_MOUSEWHEEL message on the Microsoft Windows operating system, the typical application response to a single unit of wheel information is to scroll a distance equivalent to several lines of text. The behavior is adequate when producing scroll output via a mouse wheel but is somewhat disconcerting when scroll output is produced reductively by the mouse itself. When scrolling via mouse movement, user expectation is that given a particular movement speed, the window content moves roughly as fast in the pixel space when scrolling as the cursor does when pointing.

Therefore, it can be beneficial to interpose a gain matching scheme between a reductive output and the mechanism actually used to effect one-dimensional GUI navigation. Because reductive modes offer higher dynamic range than that conventionally available, gain matching with existing navigation mechanisms generally requires that a reductive output be attenuated or in other words that a gain less than one be applied.

A standard technique for applying fractional gains via integer arithmetic is that of fractional unit accumulation. A matching variable accumulates input units until a threshold called the accumulator base is reached. Once the accumulator base is exceeded, the accumulator is divided by its base and the quotient becomes the fractional gain integral output. The division remainder is retained in the accumulator. For efficiency reasons the fractional base is normally a power of two so that division can be performed by binary shifting. For many one-dimensional navigation tasks, the minimum navigation unit is one line of text. Therefore, useful fractional gains are inversely proportional to common font sizes.

While reductive modes offer very good native dynamic range, ballistics functions can be applied in situations where even higher performance is indicated. For example, a useful navigational tool is to be able to throw the point of attention from one end of a long document to another. A sufficiently nonlinear ballistic can allow a rapid reductive motion to accomplish this task. One example of a square-law ballistic is shown in Equation 10. Arbitrarily selecting a maximum relamotive device coordinate magnitude of 128, an absolute distance measure, and a fractional accumulator base of eight yields a maximum output from a single report of roughly 32 in this exemplary embodiment. As a result, a simple square law ballistic,
g(t)=d(t)·d(t) (10)
results in approximately 32× dynamic range expansion.

Detailed Exemplary Embodiment

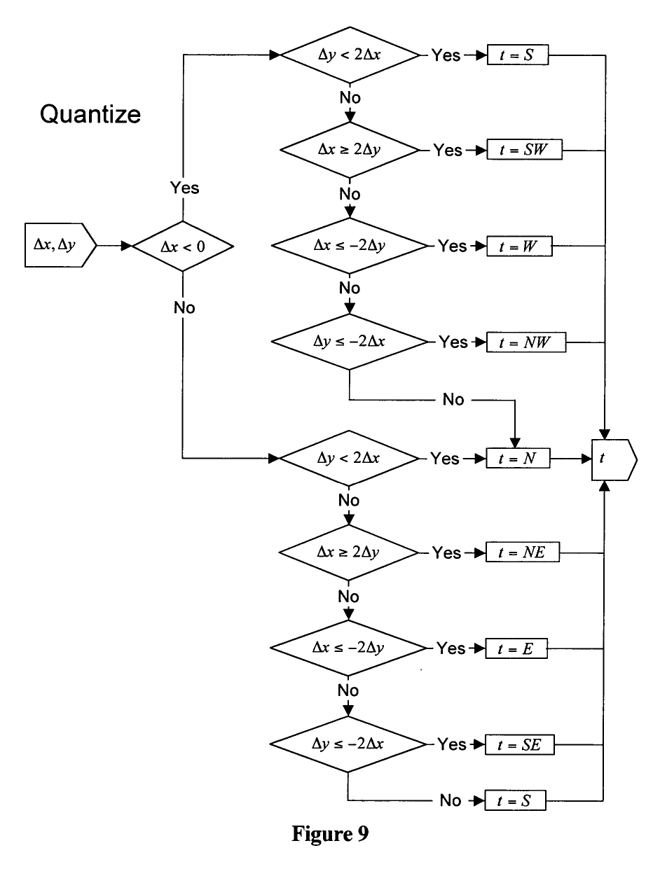

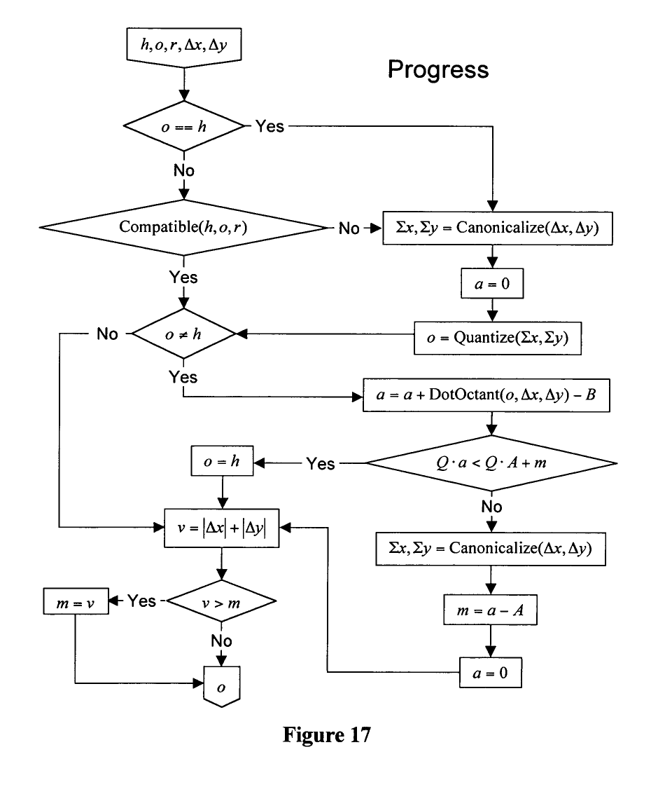

An optimized signed reductive mapping method suitable for execution by an embedded microcontroller or other processor is shown in the flow charts of FIG. 9-FIG. 25. The exemplary method uses integer arithmetic such that only an integer quotient is retained following division, and whenever possible, division and multiplication are implemented with powers of two, thereby allowing implementation by bit shifting. These features are optional, however, and may not be present in all embodiments.

For convenience, the exemplary flow charts shown and discussed herein are ordered hierarchically with lower-level procedures introduced before use by higher-level procedures. Each flowchart is named and procedures reference each other through these names. Procedure parameters can be passed by reference if the parameter name has the same name in both the definition of a procedure and its point of use, otherwise parameters may be passed by value. Again, various equivalent embodiments may vary from the detailed implementation described below.

TABLE 8

| State | | |
|---|---|---|
| Variable | Description | Possible Values |
| Σx | Accumulated Δx | Integral |
| Σy | Accumulated Δy | Integral |
| H | Current octant | N, NW, W, SW, S, SE, E, NE |
| A | Octant activity accumulator | Integral |
| M | Octant activity threshold | Integral |
| C | Current chirality | R, L, D |
| N | Chirality association counter | Integral |
| U | Conversion state | I, C |
| S | Output sign | L, D |
| F | Fractional output accumulator | Fixed point |
| P | Previous modal indicator | P, H, V |

The exemplary method operates on a two-dimensional relamotive input variable and produces a signed one-dimensional output variable in response. Two types of internal state are maintained, with one state persistent from one report to another and another state local to one report. All state variables are designed to fit within at most a sixteen bit integer representation in this implementation, although other implementations may be designed otherwise. The names and definitions of the eleven persistent state variables are shown in Table 8. Exemplary local variables are shown in Table 9. All of these state variable names herein are one letter long. Persistent variable names are uppercase and local names are lowercase. Both classes of names may have an uppercase Greek letter prefix that provides additional information about how the variable is used.

TABLE 9

| Local Variable | Description | Possible Values |
|---|---|---|
| Δx | Reported x motion | Integral |
| Δy | Reported y motion | Integral |
| r | Latest octant | N, NW, W, SW, S, SE, E, NE |
| o | Candidate octant | N, NW, W, SW, S, SE, E, NE |
| d | Candidate distance | Integral |
| e | Integral output | Integral |
| i | Current modal indicator | P, H, V |
| j, k, t, v, x, y | Temporary scratch | Integral |
| | variables | |

Predefined constants used in the exemplary flowcharts are shown in Table 10. All names of predefined constants are one or two characters long and uppercase. All constants have an underlying integral representation whose exemplary values are also shown in the table. Certain other predefined constants have different values depending upon the characteristics of the device with which the method is used. Values for these device dependent parameters are given subsequent to the description of the flowcharts.

TABLE 10

| Predefined Constant(s) | Description | Value(s) |
|---|---|---|
| N, NW, W, SW, S, SE, E, NE | Approximate headings | 0, 1, 2, |
| | | 3, 4, 5, |
| | | 6, 7 |
| I, C | Conversion state: Initial, | 0, 1 |
| | Chiral | |
| R, L, D | Chirality: Racemic, | 0, 1, −1 |
| | Levorotary, Dextrorotary | |
| P, H, V | Modal indicators: Pointing, | 0, 1, 2 |
| | Horizontal Reduction, | |
| | Vertical Reduction | |
| T, F | Boolean True, False | 1, 0 |

FIG. 9 shows an exemplary procedure for quantizing a motion report into one of eight possible octant headings. The octant names are designated via compass point abbreviations. By convention, North is aligned away from the user and East aligned to the user's right. The quantization is accomplished via five or fewer integer comparisons. A first comparison establishes whether or not movement is to the left or right. Subsequent comparisons partition the input plane using four lines with slope ½, −½, 2, and −2. These lines correspond to the partition points shown on FIG. 8. Note that the comparisons are arranged to favor smaller octants when a direction report falls directly along a partition line.

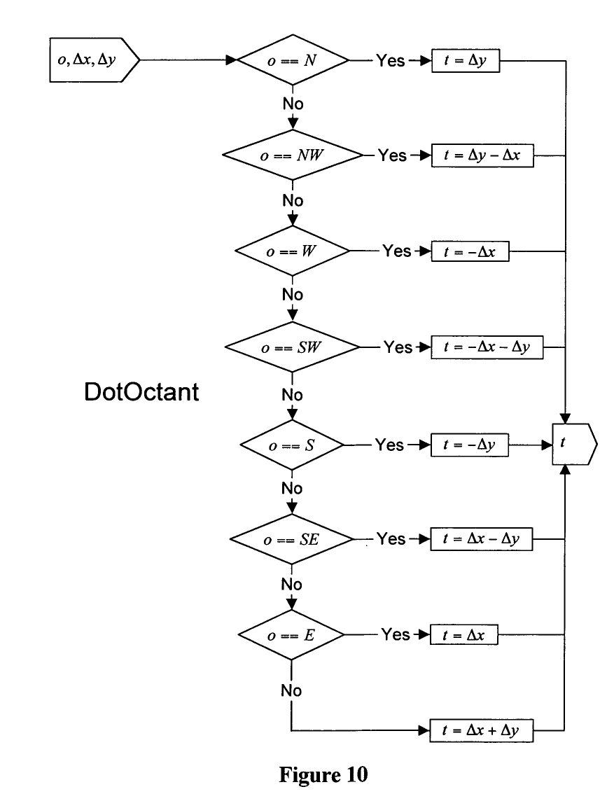

FIG. 10 shows an exemplary procedure for performing the dot product of a motion report with an octant heading. The integer result is formed from various signed combinations of the orthogonal inputs. The octant heading selects which combination to use. Note that if the input motion report lies within the input octant, the result is the sum of the absolute values of each orthogonal direction. However, motion that is orthogonal to an octant results in a zero result and motion that is antiparallel results in a negative result.

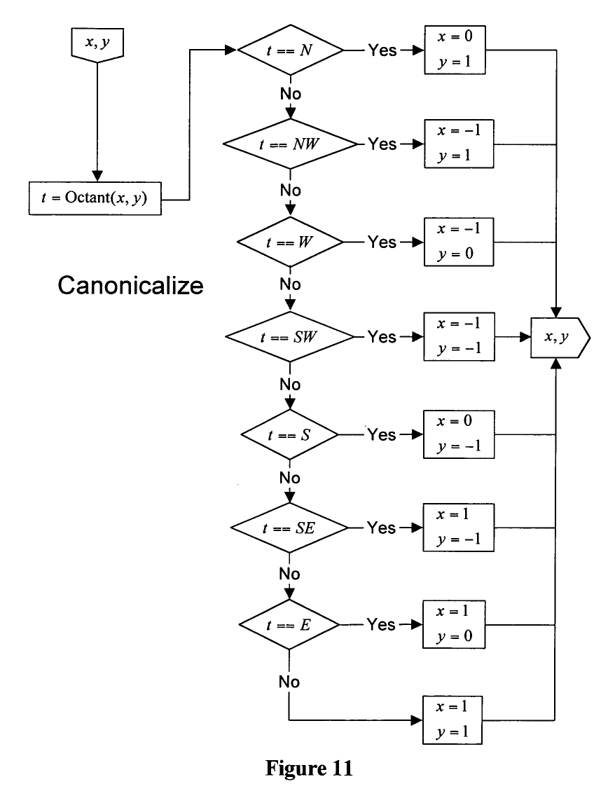

FIG. 11 shows an exemplary procedure for canonicalizing an input report. In this context, a canonical report is the smallest integral report that lies within same octant as the input. The procedure first determines the octant in which the input report lies by calling the previously described Quantize() procedure. The returned octant selects the correct pairing of 0 and ±1.

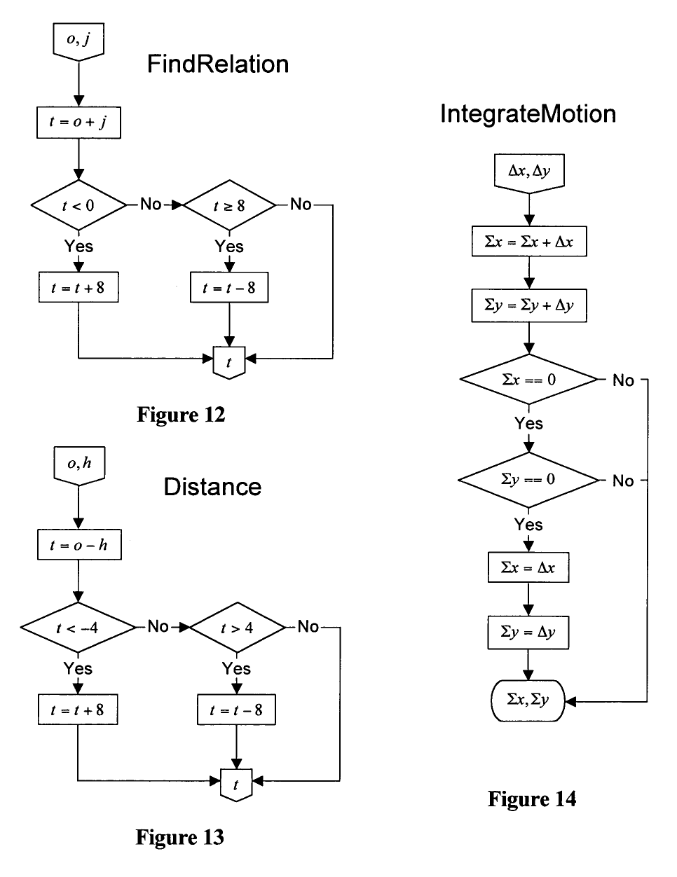

FIG. 12 shows an exemplary procedure for finding an octant with a particular rotational relationship to another octant. The first parameter of the FindRelated() procedure is the octant for which to find the related octant. The second parameter is the desired rotational relationship expressed as an integral number of octants. Positive rotational relationships specify counterclockwise rotation and negative, clockwise rotation. A tentative result is formed by summing the input octant and integral rotational relationship. If the result is greater than the largest possible octant representation then eight is subtracted. If it is less than the smallest possible octant representation then eight is added.

FIG. 13 shows an exemplary procedure for establishing the rotational distance between two octants. The distance is measured in octants and is signed. A tentative result is formed by subtracting the two source octants. Eight is added to distances less than negative four and eight is subtracted from distances greater than four. This has the effect of returning the shorter of the two possible rotational distances.

FIG. 14 shows an exemplary procedure for adding a motion report into a persistent state variable that represents the sum of a number of motions. Each coordinate of the input report is first added to its respective sum. If both sums are zero then the sums are replaced with the report. Since headings must have at least one non-zero coordinate in order to be quantized properly, this has the effect of avoiding subsequent improper quantization.

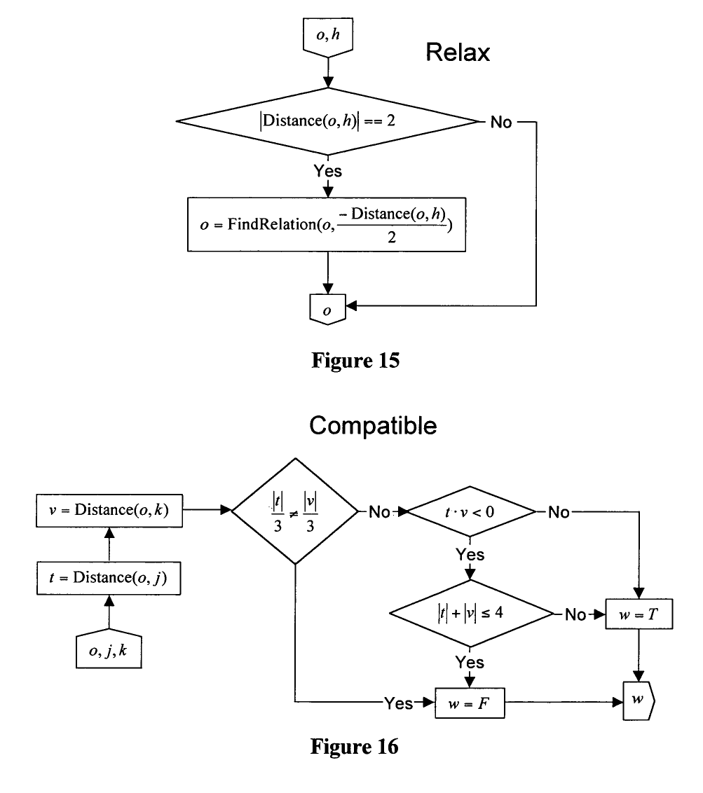

FIG. 15 shows an exemplary procedure for relaxing one octant toward another. The relaxation is performed only if the rotational distance between the octants is equal to two. The octant specified by the first parameter is relaxed toward that specified by the second. The relaxation is accomplished by finding the octant related to the first by half the rotational distance between the two. Rotational distance is measured using the Distance() procedure and the related octant is found using the FindRelated() procedure.

FIG. 16 shows an exemplary procedure for determining if a first quantized heading is compatible with two others. Compatibility means that either both the second and third octants indicate a reversal in direction from the first or that both the second and third octants indicate the same direction of turning relative to the first. In more formal terms, compatibility is indicated if the second and third octants either are both more than two octants away from the first or are both less than or equal to two octants away on the same side of the first. The computation proceeds by obtaining rotational distances between the first and second and first and third octants. These distances are divided by three and the quotients compared. If the divided distances differ then incompatibility is indicated. If not, then the sign of the two distances is compared. If they are the same then compatibility is indicated. Otherwise, the two distance magnitudes are summed. A sum greater than four indicates compatibility and a sum less than or equal to four indicates incompatibility.

shows an exemplary procedure for determining if enough motion has accumulated in the direction of a candidate octant to progress the current octant to the candidate. The result of the procedure is the candidate octant which remains unchanged if progression is to take place or is reset to the current octant if not. The procedure first compares the current and candidate octants. If these octants are identical or if they are incompatible, then a new candidate heading is obtained from the current motion report. As a side effect the octant activity accumulator is cleared. Next, the changed or unchanged candidate octant is again compared with the current octant. If the two are identical then the octant activity threshold is updated with the larger of the current activity threshold or the current instantaneous velocity before exiting the procedure. This threshold update procedure is also called from all other procedure exit paths.

If the current and candidate octants in the previous comparison are different, then the octant activity accumulator is updated and the result scaled and compared against the activity threshold augmented with a device-family-specific gain parameter. If the accumulator is less than the threshold then the candidate octant is set to the current octant before exiting the procedure. Otherwise, the candidate octant is retained. Before returning the retained candidate, the accumulated deltas are canonicalized, the activity threshold is set to the value of the activity accumulator, and the activity accumulator is cleared. Since the activity comparison uses a scaled activity value, replacement of the activity threshold with the value of the activity accumulator has the effect of relaxing the activity threshold toward zero.

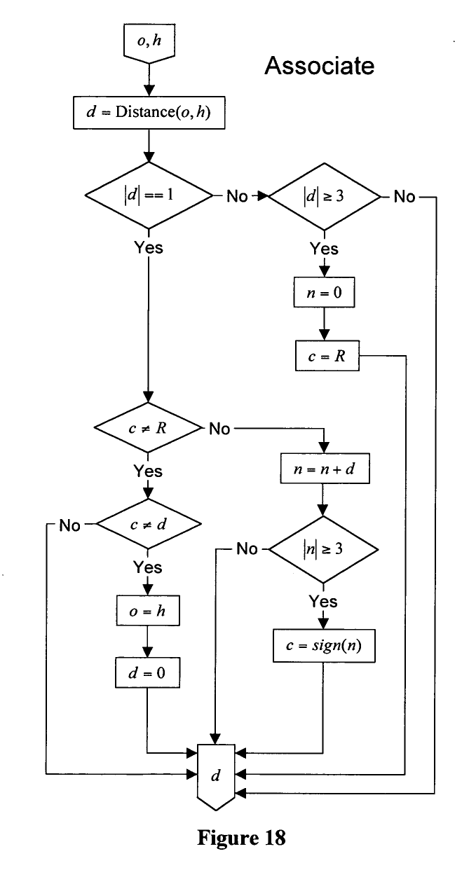

FIG. 18 shows an exemplary procedure for associating a chirality with a sign. Each time an octant heading changes the Associateo procedure is called with the current and candidate octants as parameters. A side effect of the procedure is to nullify single octant direction changes that oppose the current chirality. The procedure first calculates the rotational distance between the two octants. If the absolute distance is greater than three, indicating pending reversal, the chirality association counter is reset and the current chirality set to racemic. The distance result is returned, as is the case for all exit paths.

If the absolute rotational distance is equal to one a determination is made as to the current chirality state. If the current chirality is racemic the chirality association counter is incremented, and if its value is three or greater then the current chirality is set to the sign of the chirality association counter. If the current chirality is not racemic and the current chirality and sign of the octant distance differ, then the proposed octant progression is nullified by replacing the candidate octant with the current. The resulting distance is zeroed before exit.

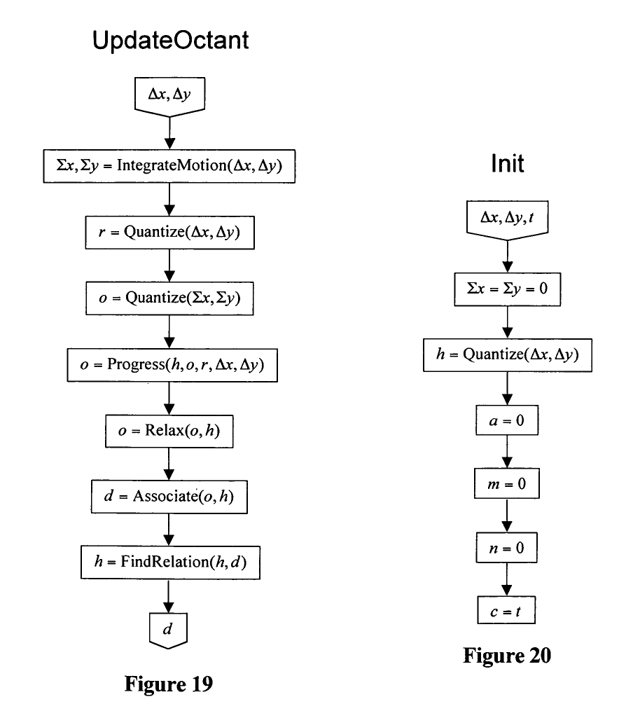

FIG. 19 shows an exemplary procedure for using a motion report to update a current quantized heading. Motion sums are first updated from the motion report. A candidate octant is obtained from the motion sums and a latest octant is obtained from the motion report. The candidate octant is filtered for sufficient octant activity and subsequently relaxed. Finally, the candidate is filtered for proper chirality association and the current heading is replaced with the candidate. Note that activity and associative filters can result in the candidate being replaced with the current octant. In such situations, the current quantized heading remains unchanged.

FIG. 20 shows an exemplary procedure for initializing direction-related persistent reductive state from an initial direction of motion and an initial chirality. Motion sums are cleared and an initial quantized heading is obtained. Subsequently, the activity accumulator, activity threshold, and chirality association counter are cleared. Finally, the current chirality is replaced with the provided initial chirality.

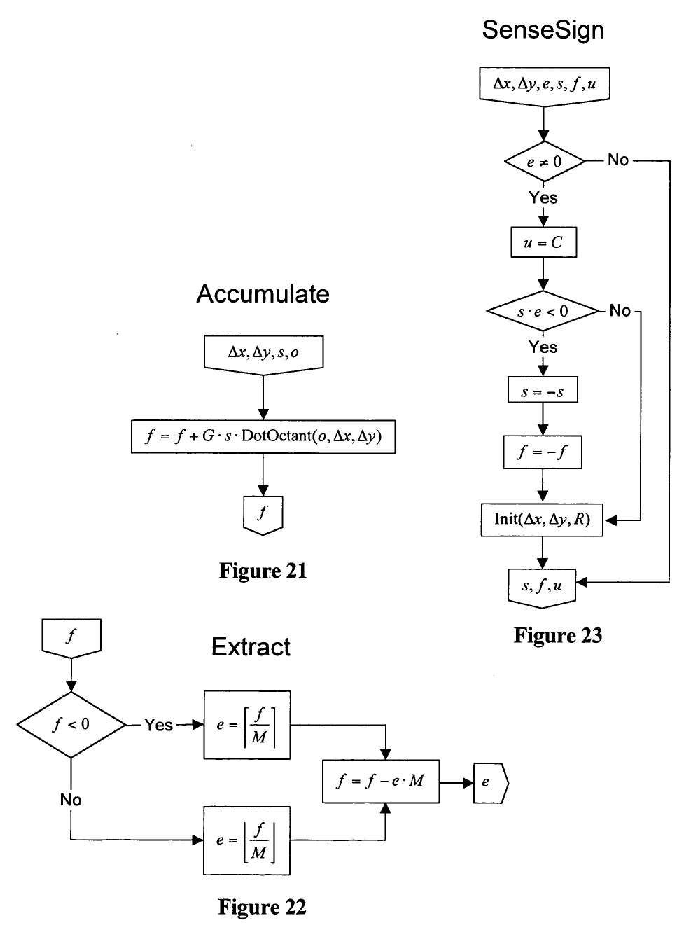

FIG. 21 shows an exemplary procedure for updating a one-dimensional fractional output accumulator from a provided motion report, sign, and octant heading. The accumulator is augmented with a dot product of the motion report and the octant heading multiplied by the sign and a context dependent gain parameter. The resulting accumulator value is returned.

FIG. 22 shows an exemplary procedure for extracting the integral portion of a fractional output accumulator. The integral portion is obtained by dividing the accumulator by its base and then rounding the result toward zero. The fraction is then updated by subtracting off the extracted integral portion multiplied by its base.

FIG. 23 shows an exemplary procedure for sensing an initial sign from a supplied extracted integral output. As a side effect a supplied output sign, output fractional accumulator and conversion state are updated. If the supplied integral output is zero, the procedure exits without performing any action. Otherwise, the supplied conversion state variable is updated to the chiral state. Next the provided sign is compared with the provided integral output. If the signs of these two values are identical then a provided motion report is used to initialize direction-related persistent reductive state with racemic chirality. Otherwise, the provided sign and fractional accumulator are negated before initialization of the persistent state.

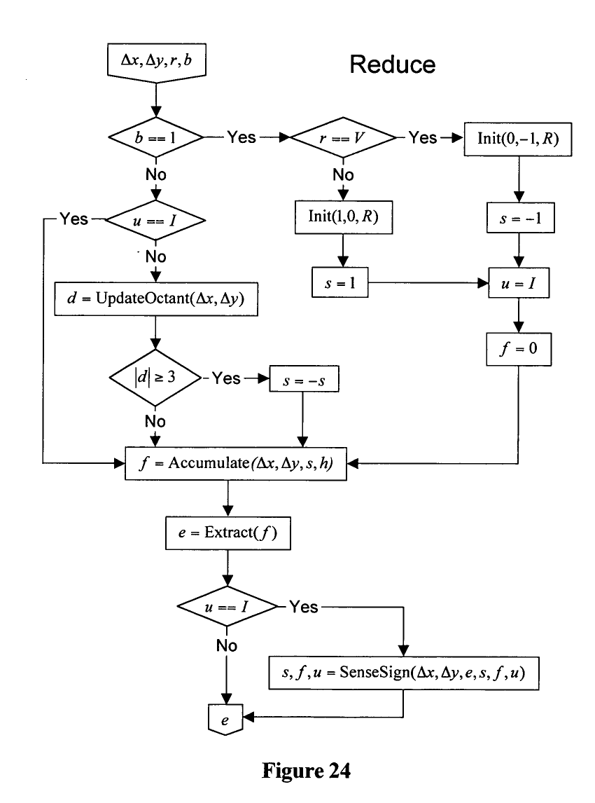

FIG. 24 shows an exemplary procedure for dimensionally reducing a supplied motion report to produce a one-dimensional result. A supplied axis parameter is used to initialize direction related persistent state. A supplied modal descriptor indicates when the reductive state should be initialized. If the descriptor is true then direction related state is initialized racemic with the supplied motion report, output sign is initialized negative for a vertical axis and positive for a horizontal axis, the output accumulator is cleared, and an internal conversion state variable is set to I. Subsequently fractional output is accumulated and integral output extracted. This is followed by sign sensing if the conversion state variable is in the I state. Sign sensing has the side effect of evolving the conversion state variable to the C state if non-zero integral output is produced in the previous extraction. This has the effect of suspending sign sensing until the supplied modal descriptor forces reductive state initialization. The accumulate, extract, sign sensing path is executed on every procedure invocation.

If the supplied modal descriptor is false and the conversion state variable is set to C then the current octant heading is updated. If the update produces a rotational magnitude greater than or equal to three octants then the output sign is inverted. Note that direction updating is not performed as long as the conversion state variable is set to I. This limits accumulated output to that produced by axis aligned input motion until such time that an initial integral output is produced and the initial sign sensed.

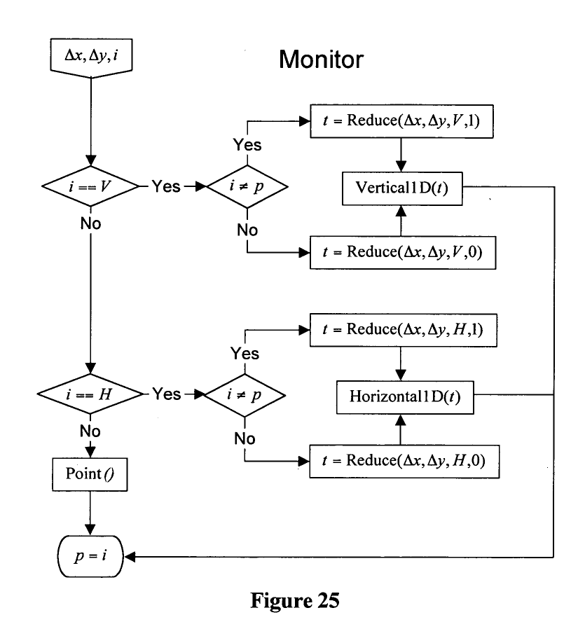

FIG. 25 shows an exemplary procedure for monitoring a device report stream augmented with extended modal information and dispatching the data either for pointing or for two different one-dimensional GUI tasks. If the extended modal information specifies that a vertically oriented GUI task be performed, then the report is dispatched for vertically oriented reduction and the result is used to perform the task. If the extended modal information specifies that a horizontally oriented GUI task be performed, then the report is dispatched for horizontally oriented reduction and the result is used to perform the task. Otherwise, the report is dispatched for pointing. If a report is dispatched for reduction an internal state variable is maintained that is true on the first reductive report subsequent to a pointing report. This state variable is used to initialize internal reductive state.

The method of FIG.9 - FIG. 25 The method is designed for use with any pointing device capable of relamotive operation. Several parameters of the method are tunable for optimal operation with different types of devices. Table 11 lists values of these parameters suitable for use with a mouse. Table 12 shows values suitable for use with a touchpad manufactured by Synaptics, Inc.

TABLE 11

| | | Exemplary |
|---|---|---|
| Parameter | Description | Mouse Value |
| A | Octant activity gain parameter | 6 |
| B | Octant activity noise parameter | 0 |
| Q | Octant activity threshold divisor | 2 |
| G | Output fractional accumulator gain | 1 |
| M | Fractional base of output accumulator | 8 |

The differences between the two devices relate primarily to gain. A touchpad has higher sensitivity than a mouse so the fractional accumulator base is larger to yield a similar feel. The octant activity gain parameter is also correspondingly larger. Since touchpads are typically noisier than mice, a non-zero touchpad activity noise parameter bleeds off octant activity and makes it more difficult to accumulate activity sufficient for progression.

TABLE 12

| | | Exemplary |
|---|---|---|
| Parameter | Description | Touchpad Value |
| A | Octant activity gain parameter | 24 |
| B | Octant activity noise parameter | 1 |
| Q | Octant activity threshold divisor | 2 |
| G | Output fractional accumulator gain | 1 |
| M | Fractional base of output accumulator | 64 |

The output fractional accumulator gain is one for both devices but can be varied to tailor the overall sensitivity of the reductive mode. Typically this parameter is customizable on a per user basis through a configuration interface.

State Progression Diagrams

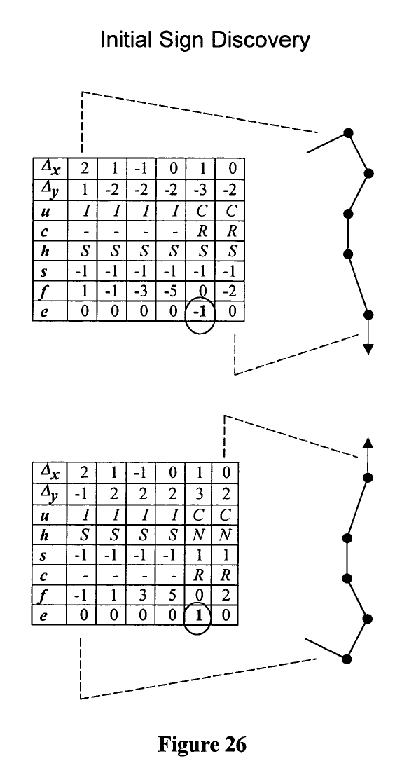

FIG. 26-FIG. 29 show the result of applying the previously-described reductive procedure to several exemplary two-dimensional paths. Each figure contains an example path and a state progression table showing reductive state progression as the path is processed. The leftmost column of the state progression table corresponds to the first segment of the path and the rightmost to the last. The persistent state values shown are those assumed subsequent to associated path segment processing.

FIG. 26 shows initial sign discovery for two vertically oriented paths, one largely traversing upward (north), and one largely downward (south). In both cases the reductive procedure is initialized with an initial southward direction and an initial negative sign. The conversion state variable is initially set to 1, indicating that no chiral progression is possible until an initial sign is discovered.

For the southward path, after an initial positive change the fractional output accumulator grows increasingly negative. This is because the positive dot product of the initial southerly octant and the southward motion is negated by the initial negative sign. By the fifth path segment, sufficient fractional output has accumulated to produce an integral output. At this point the conversion state changes to chiral, allowing rotational progression. However, since the initial heading and the input path coincide, the quantized heading is unchanged. The integral output is negative so the output sign is also unchanged.

For the northward path, after an initial negative change the fractional output accumulator grows increasingly positive. This is because the negative dot product of the initial southerly octant and the largely northward motion is made positive by multiplication with the initial negative sign. By the fifth path segment, sufficient fractional output has accumulated to produce a positive integral output. Since northward travel produced the integral output the chiral quantized heading is set to N. The integral output is positive so the sign state variable also flips to positive.

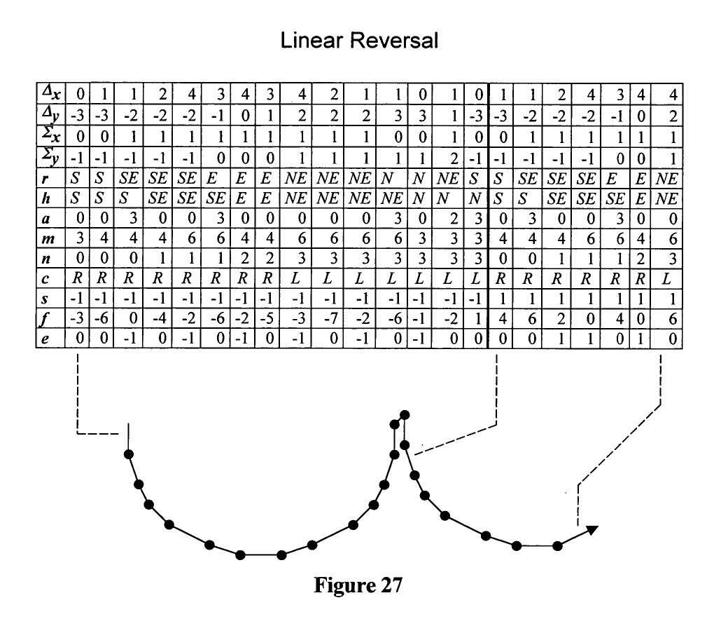

FIG. 27 shows an example input path that includes a linear direction reversal. The output sign change imparted by this direction change is demarcated with a bold line in the associated state progression table. The first thing to note from the table is that the locally accumulated deltas in rows three and four are almost always canonical. This is because canonicalization occurs both on octant progression and whenever the latest and candidate octants are incompatible. The second general pattern of note is that the current octant tends to slightly delay the latest octant. This is because the amount of motion necessary to cause an octant progression may exceed that available in a single report. For example, segment three is to the SE but the quantized heading is not adjusted from S to SE until subsequent to processing segment four, also SE. Only then does the octant activity sufficiently exceed the progression threshold. The linear reversal sign change occurs at segment sixteen where the octant heading reverses. Note that positive integral output does not occur until segment eighteen.

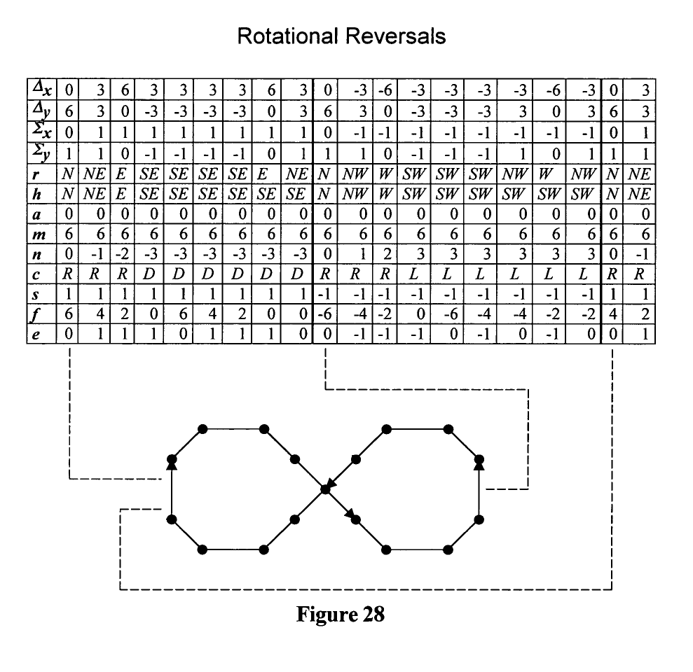

FIG. 28 shows a figure eight input path and a state progression table corresponding to slightly more than one traversal of the path. Two rotational sign reversals are induced, one at each northward segment of the path. Note that three octant changes are necessary to establish chirality. Subsequent to each chirality association, the current heading is pinned as the rotation reverses and opposes the established chirality. Reversal occurs once the direction of travel rotates another three octants. So in total, reversals occur every six octants of rotation or twice per traversal of the figure. Note that if the figure is traversed more than once, reversals will continue to be registered with the starting location.

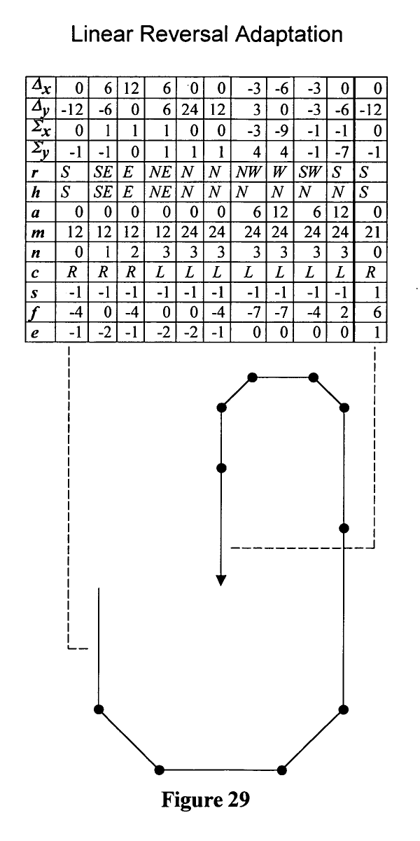

FIG. 29 shows a linear reversal that results from velocity related progression masking. An initial high-speed rotation is followed by a higher speed linear motion and then a continuing tighter, lower speed rotation. The high-speed motion increases the octant activity threshold enough so that the subsequent slower rotation generates insufficient activity to cause octant progression. As the path rotates from N to NW to W to SW the current quantized heading remains at N. Only subsequent sustained southward motion is enough to overcome the increased activity threshold, but by that time the four octant difference between N and S causes a linear reversal.

The reversal of FIG. 29 should be distinguished from the rotationally induced reversals shown in FIG. 28. The reversal of FIG. 29 is analogous to that shown in FIG. 27. It is very difficult for a human to execute a perfect trajectory reversal, so most contain at least a small amount of perpendicular rotational motion. The rapid slowing in FIG. 29 leaves behind a relatively high activity threshold and increases the amount of perpendicular motion allowable during a linear reversal.

Optional Features

A potential drawback to the previously described relamotive reductive mode is that either direction of motion and either direction of rotation can at times be tied to either output sign. This is not particularly noticeable for continuous motions as the visual feedback provided by the one-dimensional GUI task being performed yields a feeling of continuity. That is, continued user action produces movement in the same direction, and reversal produces movement in the opposite direction. However, when the pointing device is moved in non-continuous bursts of movement, this continuity is lost making it more difficult to remember which direction of motion produces the desired result. Therefore, some users may desire to reset the reductive mode to an initial state after some period of pointing device inactivity. The length of this period may be dependent upon personal preference and may be highly variable.

Further, a simpler but lower performance option uses an unsigned reductive mode. The sign is established either upon entry via extended modal information or by an initial direction of travel. In either case the sign is fixed for each invocation of the mode. Output magnitude is still proportional to input distance traveled allowing unbounded outputs.

Many other modifications and enhancements could be performed to the broad concepts set forth herein. Further, the techniques described herein could be used across a wide array of computing environments and with a wide array of input devices.

While at least one exemplary embodiment has been presented in the foregoing detailed description, it should be appreciated that a vast number of equivalent variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing exemplary embodiments, it being understood that various changes may be made in the function and arrangement of elements described without departing from the scope of the invention as set forth in the appended claims and their legal equivalents.

1. A method for indicating a desired user interface navigation task based upon a motion detected by an input device, wherein the motion comprises a first section having a first direction and a second section having a second direction substantially opposing the first direction, the method comprising the steps of:
receiving a sequence of two-dimensional signals wherein a first plurality of the two-dimensional signals corresponds to the first section of the motion and a second plurality of the two-dimensional signals corresponds to the second section of the motion;
processing at least a portion of the sequence of two-dimensional signals to determine distance measurements; and
providing a plurality of one-dimensional output signals to thereby indicate the desired user interface navigation task, wherein each of the plurality of one-dimensional output signals
is provided in response to at least one of the two-dimensional signals;
has a magnitude based upon at least a portion of the distance measurements; and
has a common polarity.

2. The method of claim 1 wherein the input device is a mouse.

3. The method of claim 1 wherein the input device is a trackball.

4. The method of claim 1 wherein the input device is a joystick.

5. The method of claim 1 wherein the input device is an inertial pointing device.

6. The method of claim 1 wherein the input device is a video game controller.

7. The method of claim 1 wherein the user interface navigation task is scrolling.

8. The method of claim 1 wherein the user interface navigation task is selecting an item from a list.

9. The method of claim 1 further comprising the step of determining the common polarity.

10. The method of claim 9 wherein the common polarity is determined from the direction of at least one of the first plurality of two-dimensional signals.

11. The method of claim 9 wherein the common polarity is a predetermined constant.

12. The method of claim 9 wherein the common polarity is determined from the configuration of the user interface.

13. The method of claim 9 wherein the common polarity is selectable by the user.

14. The method of claim 9 further comprising the step of repeating the determining step
in response to an observed dwell period of said input device.

15. The method of claim 1 wherein the receiving step further comprises receiving a third plurality of two-dimensional signals corresponding to a third section of the motion, and producing a second plurality of one-dimensional signals having an opposite polarity to the common polarity in response to the third plurality of two-dimensional signals.

16. The method of claim 15 wherein the third section of the motion corresponds to a substantial reversal of the second section of the motion.

17. The method of claim 16 wherein the reversal is an abrupt reversal.

18. The method of claim 16 wherein the reversal comprises a gradual departure from an established turning direction of the motion.

19. The method of claim 18 wherein the departure exceeds ninety degrees from the established turning direction.

20. The method of claim 18 wherein the established turning direction is determined at least in part from sufficient turning in the first and second sections of motion.

21. The method of claim 20 wherein a sufficient turning amount is substantially equal to a departure turning amount.

22. The method of claim 1 wherein the processing step comprises determining the distance measurements as a mathematical function of at least one of the two dimensional signals.

23. The method of claim 22 wherein the distance measurements are determined from magnitudes of the two-dimensional signals.

24. The method of claim 23 wherein the magnitude of each of the one-dimensional signals is substantially proportional to at least one of the distance measurements.

25. The method of claim 1 wherein the determination of the magnitudes of the one-dimensional signals comprises a mathematical function including at least one of the distance measurements.

26. The method of claim 25 wherein the mathematical function contains at least one linear section.

27. The method of claim 25 wherein the mathematical function contains at least one non-linear section.

28. The method of claim 27 wherein the non-linear section is a polynomial function.

29. The method of claim 27 wherein the non-linear section is an exponential function.

30. The method of claim 16 further comprising the step of determining a current heading associated with at least one of the two-dimensional signals.

31. The method of claim 30 wherein the current heading is associated with one of a plurality of potential headings.

32. The method of claim 31 wherein the plurality of potential headings comprises octants.

33. The method of claim 32 further comprising establishing a candidate heading.

34. The method of claim 33 further comprising the step of updating the current heading with the candidate heading.

35. The method of claim 34 wherein the updating step comprises accumulating compatible motion in the direction of the candidate heading until sufficient motion has occurred.

36. The method of claim 35 fuirther comprising the step of establishing a revised candidate heading upon motion incompatible with the candidate heading.

37. The method of claim 36 wherein motion in the direction of the current heading is compatible with a candidate heading in the direction of the current heading.

38. The method of claim 37 wherein motion in any of the three octants opposing the current heading is compatible with a candidate heading in any of the three octants opposing the current heading.

39. The method of claim 38 wherein motion in the current heading or either of the octants to the right of and closest to the current heading is compatible with a candidate heading in either of the two octants to the right of the current heading.

40. The method of claim 39 wherein motion in the current heading or either of the octants to the left of and closest to the current heading is compatible with a candidate heading in either of the two octants to the left of the current heading.

41. The method of claim 40 wherein the common polarity is changed when the current heading is updated to a candidate heading in any of the three octants opposing the current heading.

42. The method of claim 41 further comprising the step of determining an intended turning direction of the motion.

43. The method of claim 42 wherein a candidate heading is selected from the group consisting of the current heading, the three octants opposing the current heading, and the two closest octants to the current heading in the intended turning direction.

44. A method for indicating a desired user interface navigation task based upon a motion detected by an input device, the method comprising the steps of:
receiving a plurality of incremental two-dimensional signals corresponding to the motion, wherein a sum of the magnitudes of the two-dimensional signals is substantially greater than a magnitude of the sum of the two-dimensional signals;
determining a plurality of distance measurements from said plurality of incremental two-dimensional signals; and
outputting a plurality of incremental one-dimensional signals of a common polarity derived from the distance measurements to thereby indicate the desired user interface navigation task.

45. The method of claim 44 wherein the sum of the magnitudes is at least two times the magnitude of the sum of the incremental two-dimensional signals.

46. A method for using an input device to output signals configured for indicating a desired user interface navigation task, the method comprising:
providing a first motion input to said input device to generate two-dimensional output signals;
placing said input device in a dimensionality reduction mode; and
providing a second motion input to generate a plurality of one-dimensional output signals of a common polarity, wherein said second motion input includes:
a first movement in a first direction for generating a first subset of said plurality of one-dimensional output signals, each of said first subset correlated to a magnitude of a substantially different portion of said first movement; and
a second movement in a second direction substantially opposing said first direction for generating a second subset of said plurality of one-dimensional output signals, each of said second subset correlated to a magnitude of a substantially different portion of said second movement.

47. A method for indicating a user interface navigation task from a motion of a two-dimensional pointing device, the method comprising the steps of:
obtaining a plurality of incremental two-dimensional measurements of the motion, wherein a sum of magnitudes of said two-dimensional measurements is substantially greater than a magnitude of a sum of said two-dimensional measurements;
deriving a plurality of incremental one-dimensional signals from the magnitudes of said two-dimensional measurements; and
providing the plurality of incremental one-dimensional signals of a common polarity to thereby indicate the user interface navigation task.

48. A data storage medium having computer-executable instructions stored thereon for indicating a one-dimensional user interface function in response to a two-dimensional motion detected by an input device, the computer-executable instructions comprising:
a first module configured to receive a plurality of two-dimensional signals corresponding to the two-dimensional motion;
a second module configured to process the two-dimensional signals to determine at least one distance measurement and an established turning direction of the two-dimensional motion; and
a third module configured to generate the one-dimensional indication of the user interface function, wherein the one-dimensional indication comprises a magnitude determined as a function of the at least one distance measurement and a polarity determined as a function of the established turning direction of the two-dimensional motion.

49. A data processing system comprising:
an input device configured to receive a two-dimensional motion applied by a user and to produce a plurality of incremental two-dimensional signals corresponding to the two-dimensional motion;
a display configured to present a one-dimensional user interface function to the user; and
a processor coupled to the input device and to the display, wherein the processor is configured to receive the plurality of two-dimensional signals from the input device, to process the two-dimensional signals to determine at least one distance measurement, and to generate the one-dimensional indication of the user interface function on the display, wherein the one-dimensional indication comprises a magnitude determined as a function of the at least one distance measurement and a constant polarity.

50. The data processing system of claim 49 wherein the input device is a mouse.

51. The data processing system of claim 49 wherein the input device is a trackball.

52. The data processing system of claim 49 wherein the input device is a joystick.

53. The data processing system of claim 49 wherein the input device is an inertial pointing device.

54. The data processing system of claim 49 wherein the input device is a video game controller.

55. The data processing system of claim 49 wherein the user interface function is scrolling.

56. The data processing system of claim 49 wherein the user interface function is selecting an item from a list.

57. The data processing system of claim 49 wherein the processor is further configured to establish a turning direction.

58. The data processing system of claim 57 wherein:
the input device is further configured to receive a second two-dimensional motion applied by a user to produce a second plurality of incremental two-dimensional signals corresponding to the two-dimensional motion and;
the processor is further configured to receive the second plurality of incremental two-dimensional signals from the input device, to process the second plurality of two-dimensional signals to determine at least one additional distance measurement, to determine that the turning direction associated with the second plurality of two-dimensional signals is opposed to the established turning direction, and to generate a second plurality of one-dimensional indications of the user interface function on the display, wherein the second one-dimensional indications comprise a magnitude determined as a function of at least one of the additional distance measurements and a polarity opposite to the constant polarity.

59. An input device for indicating a one-dimensional user interface function in response to a two-dimensional motion provided by a user, the input device comprising:
an input module configured to produce a plurality of incremental two-dimensional signals corresponding to the two-dimensional motion;
a processing module configured to process the two-dimensional signals to determine at least one distance measurement; and
an output module configured to generate the one-dimensional indication of the user interface function, wherein the one-dimensional indication comprises a magnitude determined as a function of the at least one distance measurement and a constant polarity.

60. The input device of claim 59 further comprising a user-actuatable mode controller switch in communication with the processing module to toggle the input device between a one-dimensional mode and a two-dimensional mode.

61. The data processing system of claim 59 wherein the processor is further configured to establish a turning direction.

62. The data processing system of claim 61 wherein:
the input module is further configured to produce a second plurality of incremental two-dimensional signals corresponding to a second two-dimensional motion provided by the user and;
the processing module is further configured to receive the second plurality of incremental two-dimensional signals from the input device, to process the second plurality of two-dimensional signals to determine at least one additional distance measurement, and to determine that the turning direction associated with the second plurality of two-dimensional signals is opposed to the established turning direction and;
the output module is configured to generate a second plurality of one-dimensional indications of the user interface function on the display, wherein the second one-dimensional indications comprise a magnitude determined as a function of at least one of the additional distance measurements and a polarity opposite to the constant polarity

63. A method for producing one-dimensional user interface signals from two-dimensional motions of a relamotive pointing device comprising:
receiving as input a sequence of two-dimensional motion measurements wherein a first portion of the input motion has a direction substantially opposed by a second portion of the input motion; and
producing as output a sequence of one-dimensional signals wherein each output signal is produced substantially contemporaneously with receipt of at least one of the two-dimensional motion measurements, and
each output signal has a common polarity.

64. A method according to claim 63 wherein each output signal has a magnitude substantially determined from the contemporaneously received motion measurement.

65. A method for producing one-dimensional user interface signals from two-dimensional motions of a relamotive pointing device comprising:
receiving as input a sequence of two-dimensional motion measurements and producing as output a sequence of one-dimensional output signals wherein each output signal is produced substantially contemporaneously with at least one of the two-dimensional motion measurements, and
each output signal has a sign substantially determined from a rotational direction indicated by recently received two-dimensional motion measurements.

66. A method according to claim 65 wherein each output signal has a magnitude substantially determined from the contemporaneously received motion measurement.
